(19) United States
(12) Patent Application Publication
(10) Pub. No.: US 2026/0359305 A1
(43) Pub. Date: Nov. 12, 2026

(54) CONTEXT-DRIVEN IDENTIFICATION AND GENERATION OF DATA

(71) Applicant: Ab Initio Technology LLC, Lexington, MA (US)

(72) Inventors: Jonah Egenolf, Winchester, MA (US); Leib Malina, Dallas, TX (US); Daniel Hayman, London (GB); Nicholas Hollon, Cambridge, MA (US)

(21) Appl. No.: 19/675,295

(22) Filed: May 12, 2026

Related U.S. Application Data
(60) Provisional application No. 63/804,153, filed on May 12, 2025.
(60) Provisional application No. 63/821,850, filed on Jun. 11, 2025.

(51) Int. Cl. G06F 16/2457; G06F 16/2455

(52) U.S. Cl. CPC G06F 16/24575; G06F 16/2456

(57) ABSTRACT

Disclosed are methods, systems, and computer-readable media for efficiently identifying data for responding to a request by identifying metadata candidates specifying contexts of available data, utilizing an interpreter to select a candidate, based on the selection, retrieving additional metadata specifying additional contexts and using that additional metadata to identify the data for the response to the request. In an example, a method includes receiving a request and identifying metadata specifying contexts as candidates for selection by an interpreter. Information identifying the candidates and instructions to select a candidate based on the request is provided to the interpreter. An indication of a candidate selected is received, and additional metadata associated with the candidate is identified. Based on the selected candidate and additional metadata, data for generating a response is identified and used to generate the response.

### CROSS-REFERENCE TO RELATED APPLICATIONS

This application claims priority to and benefit of U.S. Provisional Patent Application Nos. 63/804,153, filed May 12, 2025, and 63/821,850, filed Jun. 11, 2025, the entire contents of each of which are incorporated herein by reference.

### BACKGROUND

Modern data processing systems manage vast amounts of data within an enterprise. A large enterprise, for example, may have millions of datasets. These datasets can support multiple aspects of the operation of the enterprise. Complex data processing systems typically process data in multiple stages, with the results produced by one stage being fed into the next stage. The overall flow of information through such systems may be described in terms of a directed dataflow graph, with nodes or vertices in the graph representing components (either data files or processes), and the links or “edges” in the graph indicating flows of data between the components. A system for executing such graph-based computations is described in U.S. Pat. No. 5,966,072, titled “Executing Computations Expressed as Graphs,” incorporated herein by reference.

### SUMMARY

The present disclosure describes techniques for efficiently identifying data to satisfy a request by leveraging metadata that specifies the contexts of available enterprise data. Rather than navigating rigid physical database schemas, the system leverages a metadata model to identify an initial set of metadata candidates that provide an abstracted, logical view of the data's environment, such as a relevant data domain or other high-level semantic cluster. The system then utilizes an interpreter, such as an artificial intelligence service, to evaluate and select the candidate(s) that most accurately align with the semantic intent of the request. By processing these logical views instead of complex physical data, the interpreter is able to map the intent of the request directly to logical elements while operating within computational memory limits.

Based on this initial selection, the techniques dynamically retrieve additional metadata specifying progressively deeper contexts. This establishes a multi-stage retrieval workflow that systematically compresses the search space, iteratively narrowing the focus from broad enterprise domains down to specific datasets and individual logical fields. The system then uses this progressively retrieved additional metadata to identify the data needed to generate a response to the request. Once a targeted set of logical fields is curated through this iterative context resolution, the techniques compile the selection into a declarative specification. A specialized data builder subsequently transforms this specification into executable instructions, automatically integrating the physical join mechanics embedded within the metadata model into the logic to enable deterministic, automated data materialization.

In general, in a first aspect, a method for efficiently identifying data for responding to a request by identifying metadata candidates specifying contexts of available data, utilizing an interpreter to select a candidate, based on the selection, retrieving additional metadata specifying additional contexts and using that additional metadata to identify the data for the response to the request, includes: receiving, by a data processing system, a request, the data processing system being configured to access data stored in one or more data sources; accessing, by the data processing system, a metadata repository that stores items of metadata specifying contexts of at least some of the data stored in the one or more data sources; based on the accessing, identifying, by the data processing system, one or more of the items of metadata specifying the contexts as candidates for selection by an interpreter; providing, to the interpreter, information identifying the candidates and one or more instructions to select at least one of the candidates based on the request; receiving, from the interpreter, an indication of a candidate selected from the candidates; identifying, from among the items of metadata specifying the contexts, one or more additional items of metadata associated with the candidate selected; based on the candidate selected and the one or more additional items of metadata, identifying at least a portion of the data stored in the one or more data sources for generating a response to the request; and based on at least the portion of the data identified, generating, by the data processing system, the response to the request.

In a second aspect combinable with the first aspect, a context specifies a semantic meaning of an item of data stored in the one or more data sources.

In a third aspect combinable with the first or second aspects, the interpreter includes an artificial intelligence (AI) service or a client device.

In a fourth aspect combinable with the third aspect, the AI service includes an AI model configured to select a candidate based on the information identifying the candidates.

In a fifth aspect combinable with any of the first through fourth aspects, providing, to the interpreter, the information identifying the candidates includes causing a client device to render a user interface displaying visualizations of the candidates.

In a sixth aspect combinable with any of the first through fifth aspects, the method includes providing, to the interpreter, information specifying the request.

In a seventh aspect combinable with any of the first through sixth aspects, generating the response to the request includes: generating, by the data processing system, instructions configured to access the at least a portion of the data stored in the one or more data sources and to output, based on the accessed data, the response to the request; and executing, by the data processing system, the instructions on the at least a portion of the data stored in the one or more data sources to output the response.

In an eighth aspect combinable with the seventh aspect, generating the response to the request includes: determining, based on the candidate selected and the one or more additional items of metadata, one or more operations to be performed on the at least a portion of the data; where generating the instructions includes generating instructions configured to perform the one or more operations on the at least a portion of the data; and where executing the instructions includes performing the one or more operations on the at least a portion of the data.

In a ninth aspect combinable with the seventh aspect, generating the response to the request includes: identifying one or more keys for joining the identified data; where generating the instructions includes generating instructions configured to join the identified data based on the one or more keys; and where executing the instructions includes joining the identified data based on the one or more keys.

In a tenth aspect combinable with any of the first through ninth aspects, the method includes: identifying technical metadata corresponding to at least one of the candidate selected or the one or more additional items of metadata; and based on the technical metadata, identifying the at least a portion of the data stored in the one or more data sources for generating a response to the request.

In an eleventh aspect combinable with any of the first through tenth aspects, each of the one or more items of metadata is associated with a group of data, and the one or more additional items of metadata are associated with data within the group corresponding to the candidate selected.

In a twelfth aspect combinable with any of the first through eleventh aspects, the candidate selected represents a data domain, and the one or more additional items of metadata represent datasets within the data domain.

In a thirteenth aspect combinable with any of the first through twelfth aspects, the one or more additional items of metadata represent a collection of related datasets or fields in the collection of related datasets.

In a fourteenth aspect combinable with the thirteenth aspect, the method includes determining, from within the collection of related datasets, a driving dataset for responding to the request, the driving dataset determining a result grain for responding to the request.

In a fifteenth aspect combinable with any of the first through fourteenth aspects, the candidate selected represents a dataset, and the additional items of metadata represent fields related to the dataset.

In a sixteenth aspect combinable with any of the first through fifteenth aspects, the method includes: providing, to the interpreter, information identifying the one or more additional items of metadata and one or more instructions to select, based on the request, at least one of the one or more additional items of metadata; and receiving, from the interpreter, an indication of at least one of the one or more additional items of metadata; where the data of the one or more data sources to be used in responding to the request is identified based on the at least one of the one or more additional items of metadata.

In a seventeenth aspect combinable with the sixteenth aspect, the method includes: determining one or more errors associated with the at least one of the one or more additional items of metadata identified; and providing instructions to the interpreter to select a candidate from the candidates based on the one or more errors.

In an eighteenth aspect combinable with any of the first through seventeenth aspects, identifying the additional items of metadata includes: accessing a metadata model that includes data representing the items of metadata and relationships among the items of metadata; identifying, in the metadata model, the candidate selected; and traversing the metadata model to identify the one or more additional items of metadata.

In a nineteenth aspect combinable with the eighteenth aspect, the metadata model includes nodes representing the items of metadata and edges representing relationships among the items of metadata, and where traversing the metadata model includes traversing one or more edges associated with a node representing the candidate selected to identify one or more other nodes representing the one or more additional items of metadata.

In a twentieth aspect combinable with any of the first through nineteenth aspects, the method includes: identifying one or more rules associated with the candidate selected; and determining at least one of the one or more additional items of metadata by applying the one or more rules.

In a twenty-first aspect combinable with any of the first through twentieth aspects, the one or more instructions provided to the interpreter include instructions to select at least one of the candidates by applying one or more matching rules to match one or more portions of the request to the candidates.

In a twenty-second aspect combinable with any of the first through twenty-first aspects, identifying the one or more items of metadata includes: determining, based on the request, a type of metadata; and identifying, from the metadata repository, the one or more items of metadata of the determined type as candidates for selection by an interpreter.

In a twenty-third aspect combinable with any of the first through twenty-second aspects, the method includes: accessing a workflow that specifies a sequence of operations for identifying at least a portion of the data, where at least some of the operations in the sequence are to be performed by one of multiple interpreters; and based on the workflow, providing, to the interpreter, the information identifying the candidates and the one or more instructions to select at least one of the candidates.

In a twenty-fourth aspect combinable with the twenty-third aspect, the method includes: identifying, based on the workflow, a second interpreter of the multiple interpreters for selecting at least one of the one or more additional items of metadata for responding to the request; and providing, to the second interpreter, information identifying the one or more additional items of metadata and one or more instructions to select, based on the request, at least one of the one or more additional items of metadata.

In a twenty-fifth aspect combinable with any of the first through twenty-fourth aspects, the method includes: maintaining a workflow state that tracks outputs of multiple interpreters; and providing, to the interpreter, information identifying at least a portion of the workflow state to provide context for selecting the candidate.

In a twenty-sixth aspect combinable with any of the first through twenty-fifth aspects, the method includes storing at least one of the one or more items of metadata or the additional items of metadata in a cache.

In a twenty-seventh aspect combinable with any of the first through twenty-sixth aspects, the method includes: providing, to each of multiple interpreters, a portion of the one or more additional items of metadata and one or more instructions to select, from the portion, items of metadata for responding to the request; receiving, from each of the multiple interpreters, selected items of metadata from the respective portion; and generating the response based on the selected items of metadata received from each of the multiple interpreters.

In a twenty-eighth aspect combinable with any of the first through twenty-seventh aspects, the method includes providing, to the interpreter, instructions to determine whether all components of the request are satisfied based on the candidate selected and the one or more additional items of metadata.

In a twenty-ninth aspect combinable with any of the first through twenty-eighth aspects, the method includes: providing, to the interpreter, one or more instructions to generate a declarative specification for identifying the at least a portion of the data for generating the response to the request; receiving, from the interpreter, the declarative specification; and based on the declarative specification, generating executable instructions for outputting the response to the request.

In a thirtieth aspect combinable with any of the first through twenty-ninth aspects, the method includes storing the generated response or transmitting the generated response to a user.

In a thirty-first aspect combinable with any of the first through thirtieth aspects, the method includes: identifying contextual information for the request based on a user associated with the request or a location within a user interface from which the request was initiated; and identifying, based on the contextual information, the one or more items of metadata specifying the contexts; or providing the contextual information to the interpreter to guide the selection of the candidate.

In a thirty-second aspect combinable with any of the first through thirty-first aspects, the method includes providing, to the interpreter, information identifying functions available to the interpreter for responding to the request.

In general, in a thirty-third aspect, a system includes one or more processors and memory storing instructions executable by the one or more processors to perform the method of any of the first through thirty-second aspects.

In general, in a thirty-fourth aspect, one or more non-transitory computer-readable mediums store instructions executable by one or more processors to perform the method of any of the first through thirty-second aspects.

In general, in a thirty-fifth aspect, an apparatus includes one or more processors and memory storing instructions executable by the one or more processors to perform the method of any of the first through thirty-second aspects.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One or more of the above aspects may provide one or more of the following advantages.

The described techniques can drastically improve the computational efficiency, processing accuracy, and processing latency relative to conventional data retrieval techniques. In some architectures, extracting data across disparate sources involves computationally expensive traversal of complex physical schemas and execution of multiple queries to resolve physical joins. The present disclosure addresses these and other inefficiencies by using a logical metadata model that abstracts away the complexities of physical data, thereby avoiding the consumption of computational resources needed to traverse the physical data and resolve physical joins. In addition, by using a retrieval workflow that evaluates logical views of the metadata as opposed to the underlying physical data, the disclosed techniques compress the search space for data. This architectural shift significantly decreases processing latency due to the reduced search space and lack of physical data operations, improves accuracy by preventing the structural and calculative errors inherent to physical data approaches, and enables the system to deterministically compile a semantic request into executable instructions in a fraction of the usual processing time.

This architectural shift also resolves a primary technical hurdle in utilizing artificial intelligence for database queries (e.g., traditional text-to-SQL applications). In approaches that feed physical schemas into the context window of an interpreter, the context window increases significantly as the amount of data and number of schemas grow, leading to token exhaustion, increased processing latency, and model hallucination. By dynamically generating flattened views of available data, the system abstracts the physical complexity of data such that interpreters do not need to process underlying join logic or relationship edges. This improves computational efficiency by avoiding the consumption of computational resources associated with processing the underlying join logic. In addition, the described workflow progressively reduces the search space of data for responding to a request from, e.g., an entire organizational catalog down to a specific domain, then to a domain island, and finally to a curated set of targeted fields. Unlike text-to-SQL approaches, this highly efficient context compression ensures interpreters operate within memory limits while maintaining computational precision.

To further improve data processing accuracy, the described techniques separate non-deterministic intent resolution (e.g., identifying relevant data based on the semantic intent of the request) from deterministic materialization (e.g., materializing the identified data to produce the response to the request). In the disclosed system, interpreters operate on logical metadata to generate a declarative specification containing order-independent operations. A downstream data builder then receives this declarative specification and generates executable instructions (e.g., an executable dataflow graph). By delegating physical execution to the data builder, the architecture shifts the burden of complex joins, foreign key traversal, and physical schema mapping away from non-deterministic artificial intelligence models (or other interpreters) and onto a robust, deterministic execution engine. This shift improves data processing accuracy because it avoids relying on non-deterministic, error prone interpreters to resolve the complexities of relationships among physical data.

In some examples, to data processing accuracy relative to single-interpreter (e.g., single agent) systems, the techniques described herein can implement multi-agent workflow. Specifically, the workflow can utilize a reviewer pattern that separates “actor” agents from “critic” agents. For example, during field curation, a field selection agent can be configured to focus on identifying the minimal set of fields for responding to a request, while an architect agent maps selected fields to operations, forcing a technical burden of proof for every included field. A distinct reviewer agent then evaluates the output for completeness. This structural counterbalance minimizes over-selection typical of “filtration down” approaches and the under-selection of “selection up” approaches, thereby improving data processing accuracy.

In some data environments, governance rules may be applied to data in an ad-hoc manner, leading to structural execution errors and inaccurate outputs. The techniques described herein utilize a metadata model where controls, such as data quality rules and security protocols, are explicitly linked to logical metadata. As a result, the appropriate controls can be automatically applied to selected items of metadata, obviating data processing errors associated with missed or inaccurate controls. In addition, when a data builder generates instructions to retrieve data based on the selected metadata, it automatically enforces the appropriate controls, ensuring that the correct governed data is produces. This prevents reliance on ad-hoc application of controls and improves the fidelity of governance across the computing environment.

When execution failures occur, surfacing raw, low-level system errors to users or artificial intelligence models can result in infinite retry loops that drain computational resources without resolution. The techniques described herein implement advanced error analysis and data review subgraphs to act as intelligent quality gates. If the data builder encounters a structural error or returns unexpected data (e.g., returning thousands of rows when a single count aggregation was requested), a data review agent intercepts the raw output. The system can deploy a diagnostic workflow configured to diagnose the root cause of failures and invoke appropriate remedial action. This shifts troubleshooting from blind debugging to active, data-driven programmatic investigation, rapidly restoring accuracy and avoiding computational waste.

In some examples, the techniques described herein can improve computational efficiency and reduce storage requirements by storing a logical definition of the data rather than immediately materializing the data. By storing (e.g., in a data catalog or data marketplace) the definition of the data rather than materializing it, the techniques described herein can reduce physical storage requirements and computational processing costs. Upon registration, the metadata model can be automatically updated to integrate the new nodes and relationships, which can provide logical access to the data without the physical cost of materialization. When a downstream consumer accesses the registered dataset, the data builder retrieves the definition, executes the logic across disparate sources, and dynamically applies controls, such as masking sensitive information or executing data quality filters, at the time when materialization is requested.

In some examples, the techniques described herein improve computational efficiency by automatically grounding requests based on contextual information. By mapping specific user interface locations or identifiers to navigation context candidates, strategy candidates, and prompt templates, the system can dynamically guide the execution workflow. This contextual grounding can ensure that prompts transmitted to the interpreters are automatically restricted to appropriate technical boundaries, effectively steering the interpreter toward valid, executable responses tailored to the specific application environment from which the request was initiated without requiring extensive processing or clarification loops. In this way, the described techniques can improve data processing accuracy and avoid computational waste due to erroneous calculations, relative to techniques that do not leverage such contextual information.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a diagram of an example process for responding to a request for data within an enterprise.

FIGS. 2A-2D are diagrams of example systems for context-driven data identification and generation.

FIGS. 3A-3H are diagrams of example systems showing stages of an adaptive query workflow for context-driven data identification and generation.

FIG. 4 is a diagram of an example metadata model.

FIG. 5 is a flow diagram of an example process for context-driven data identification and materialization.

FIG. 6 is a diagram of an example computer system.

Like reference numerals in the various drawings indicate like elements.

### DETAILED DESCRIPTION

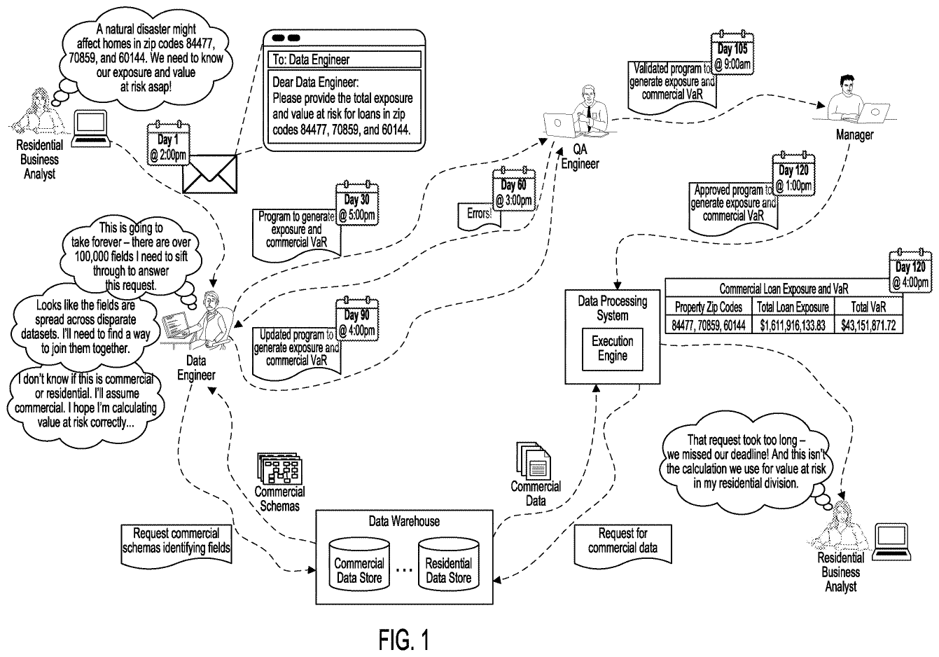

FIG. 1 illustrates an example process 100 for responding to a request for data within an enterprise. This example highlights the technical bottlenecks and data governance issues that can arise in large-scale data ecosystems having millions of datasets spread across thousands of discrete repositories.

The process 100 begins at 2:00 pm on Day 1 when a residential business analyst submits a request for information. The residential business analyst notes that a natural disaster might affect homes in specific zip codes (e.g., zip codes 84477, 70859, and 60144) and expresses an urgent need to determine the total exposure and value at risk (VaR) for those locations. A data engineer receives this request with instructions to provide the total exposure and VaR for loans associated with said zip codes.

Upon receiving the request, the data engineer identifies a set of significant technical hurdles. The data engineer observes that the search involves sifting through over 100,000 fields, a task that can take an extensive amount of time to complete. Furthermore, the data engineer notes that the relevant fields appear to be spread across disparate datasets, necessitating the identification of a way to join these datasets together to form a cohesive response.

The data engineer is also forced to rely on technical guesswork due to the lack of an automated manner to resolve context or semantic intent for the request. For instance, the data engineer voices uncertainty regarding whether the analyst requires commercial or residential data and, without a mechanism for automated context resolution, assumes the request pertains to commercial data. The data engineer further expresses a hope that the VaR is being calculated correctly, illustrating a lack of inherent governance in the process. Based on these assumptions, the data engineer sends a request for commercial schemas to a data warehouse to identify potential fields. The data warehouse can include a commercial data store and a residential data store.

The workflow continues through a protracted sequence of development and review. At Day 30 at 5:00 pm, the data engineer finishes a program to generate exposure and commercial VaR. At Day 60 at 3:00 pm, a QA engineer identifies a set of errors within the program, and sends a report of the errors to the data engineer. This feedback triggers the data engineer to rework the application, resulting in an updated program at Day 90 at 4:00 pm. This updated program is sent to the QA engineer, who finally validates the program at Day 105 at 9:00 am.

The process reaches its final stages at Day 120 at 1:00 pm when a manager approves the program. A data processing system, employing an execution engine, then runs the approved program to request commercial data from the data warehouse and transform it to produce the requested data. By Day 120 at 4:00 pm, the system outputs a report titled “Commercial Loan Exposure and VaR” providing values for zip codes 84477, 70859, and 60144, such as a total loan exposure of $1,611,916,133.83 and a total VaR of $43,151,871.72.

Despite this 120-day effort, the process 100 fails to meet the technical and business requirements of the request. The residential business analyst notes that the delay was too long, causing a missed deadline. Critically, the analyst identifies that the output is fundamentally incorrect because the system applied a commercial calculation instead of the specific calculation used by the residential division.

The example process 100 showcases the technical challenges associated with navigating complex physical schemas within large-scale data environments. The technical effort associated with identifying and mapping specific data items from a search space of over 100,000 fields can lead to incorrect data and significant latency in responding to requests. Furthermore, a reliance on manual interpretation of data requests can result in a mismatch between the semantic intent of a request and the physical data retrieved for the response.

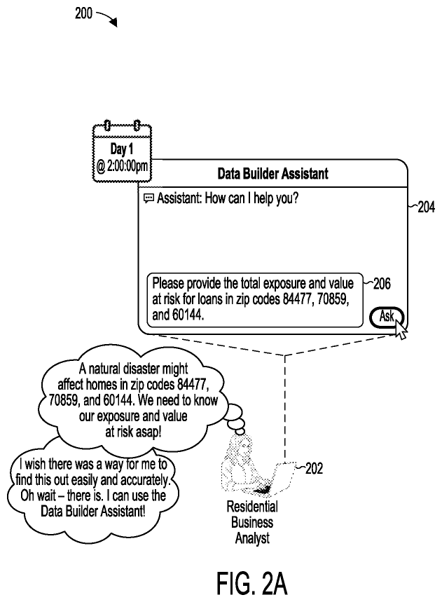

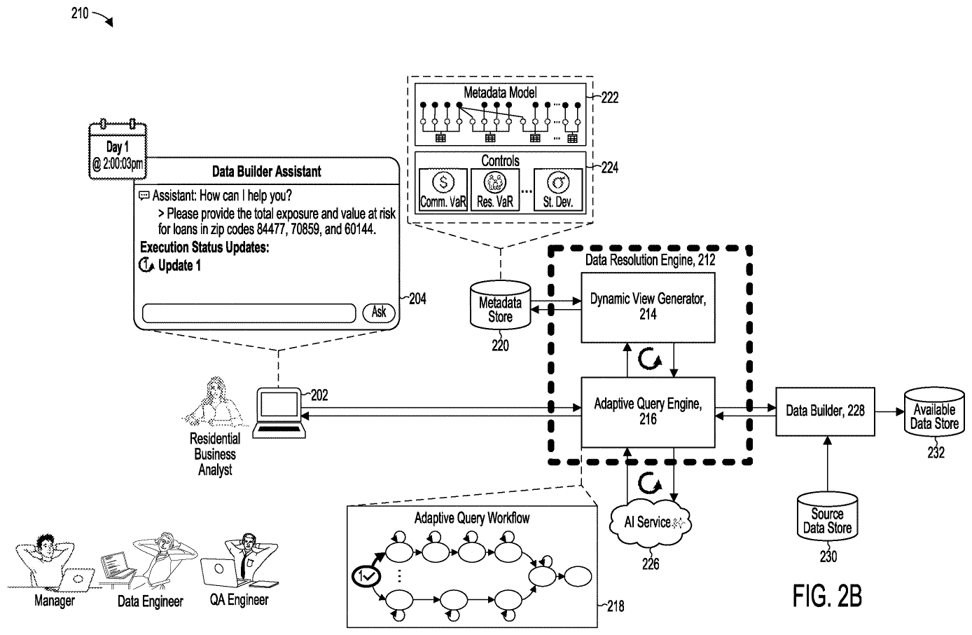

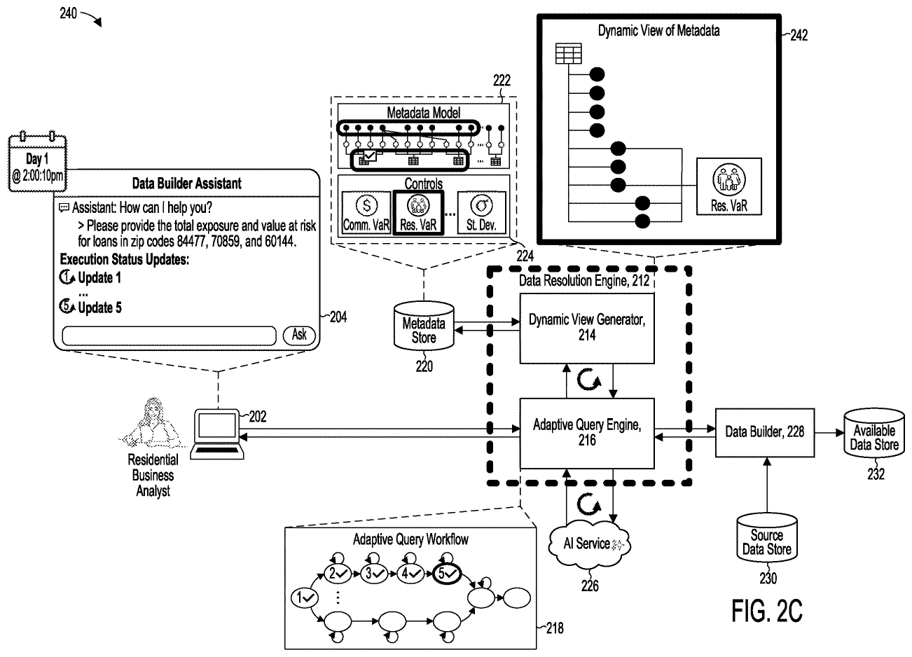

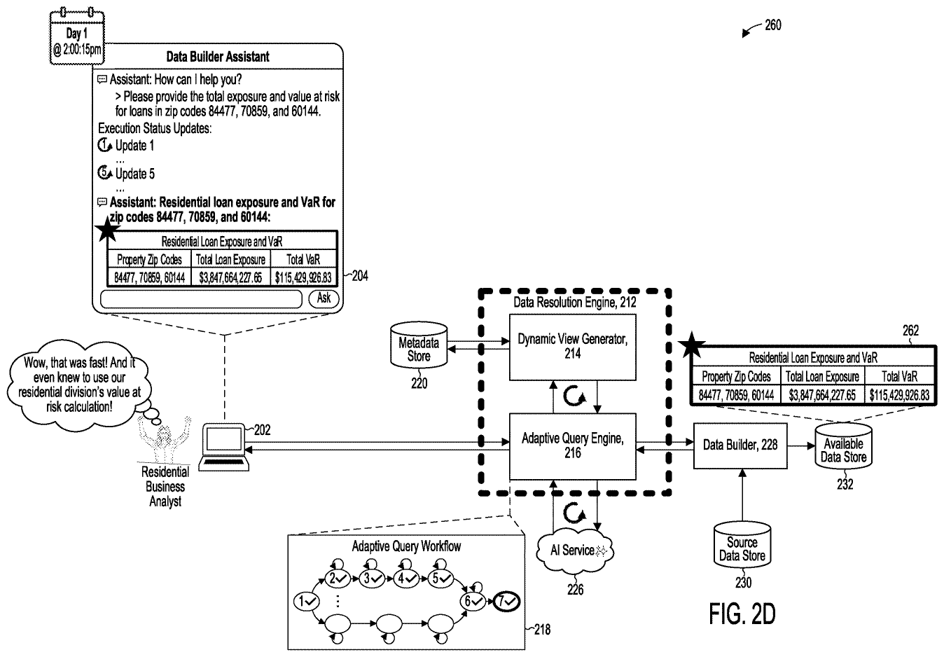

FIG. 2A illustrates an example environment 200 for initiating a context-driven data identification and generation process. Much like the example illustrated in FIG. 1, the example in FIG. 2A begins at Day 1 at 2:00:00 pm with a user (e.g., a residential business analyst) facing a natural disaster that may affect homes in specific zip codes, such as zip codes 84477, 70859, and 60144, and expressing a need to understand the exposure and value at risk (VaR) for these locations immediately.

In this example, the residential business analyst uses a client device 202 to access a “Data Builder Assistant” interface 204 of the environment 200. The client device 202 can include a computer system, a handheld device, or any other set of hardware configured to render a user interface and transmit data. The residential business analyst can use the client device 202 to enter a natural language request into an input portion 206 of the user interface 204. In this example, the natural language request specifies: “Please provide the total exposure and value at risk for loans in zip codes 84477, 70859, and 60144.” Once the request is entered, the residential business analyst can use the client device 202 to select a control (e.g., an “Ask” button) to transmit the request to a data processing system.

As described in detail herein, upon initiating the request through the “Data Builder Assistant” user interface 204, a sequence of operations can be carried out to efficiently identify data relevant to the request in order to generate a response to the business analyst's logical question without the lengthy delay or the errors illustrated in FIG. 1. This context-driven approach provides the technical advantage of reducing the search space from an organizational catalog (e.g., over 100,000 or 1,000,000 fields) to a focused subset of metadata candidates, which facilitates the identification of appropriate data within context limits. Furthermore, this approach ensures that the intent of the request, such as the specific data domain (e.g., residential) and calculation metrics (e.g., residential VaR), is captured and governed by a metadata model, thereby eliminating the reliance on unverified technical assumptions that can lead to inaccurate responses.

FIG. 2B illustrates an example environment 210 for planning a response to a request as part of a context-driven data identification and generation process. Specifically, the environment 210 depicts an initial portion of the process in which a specific technical workflow for responding to a request is determined.

In this example, the environment 210 includes a data resolution engine 212 having a dynamic view generator 214 and an adaptive query engine 216 that coordinate to resolve data for responding to a request. The data resolution engine 212 and its components can be implemented as a set of software instructions executed on a data processing system, a set of distributed processors, or a central server, among others. In some examples, these components can be deployed as a set of containerized microservices within a cloud data fabric or other cloud computing environment.

The adaptive query engine 216 can serve as an orchestration component that manages the state and technical logic of a response by identifying and implementing an adaptive query workflow 218. The adaptive query workflow 218 can include a workflow (e.g., an agentic workflow) that specifies operations for identifying data, where at least some operations in the workflow are performed by an agent or interpreter. Such an agentic workflow can include a subgraph of specialized AI agents configured to resolve technical sub-tasks, such as utilizing a multi-agent reviewer pattern where an actor agent proposes a technical solution and a critic agent validates the proposal against the request to ensure it satisfies one or more criteria (e.g., completeness). The adaptive query engine 216 uses the adaptive query workflow 218 to decide technical actions and sends an indication to the dynamic view generator 214 when specific metadata is needed to progress the workflow.

To perform one or more operations in the adaptive query workflow 218, the adaptive query engine 216 coordinates with an interpreter, such as an AI service 226 or a client device (e.g., the client device 202 via the user interface 204). In general, the AI service 226 can include a set of computational agents, heuristic engines, and/or artificial intelligence models configured to perform automated reasoning and decision-making. In some examples, the AI service 226 can include a large language model (LLM), a generative AI model, a set of neural networks, a transformer-based architecture, or any other set of machine learning algorithms or statistical models configured to evaluate semantic intent. The AI service 226 can be implemented as a remote service accessed via an application programming interface (API), a locally hosted software assembly, and/or a set of specialized hardware accelerators. In some examples, the AI service 226 serves as a technical catchall for any hardware or software system capable of interpreting natural language instructions, classifying data, or selecting among technical candidates based on a determined context. Additionally, in some examples, a user of the client device (e.g., via the user interface 204 or another interface) can perform one or more of the operations described as being performed by the AI service 226. For example, the user interface 204 can render a set of metadata candidates as selectable elements, allowing a user to act as the interpreter to select the appropriate technical fields for a response.

The dynamic view generator 214 is configured to interact with a metadata store 220 to obtain items of metadata for use in identifying data for responding to the request. For example, responsive to an indication from the adaptive query engine 216, the dynamic view generator 214 can query the metadata store 220 for items of metadata and can process the retrieved metadata into a format that can be utilized by the adaptive query engine 216. For example, the dynamic view generator 214 can produce a list of requested metadata that identifies the data available for responding to the request without requiring knowledge of low-level database joins or physical schemas. To facilitate understanding, the metadata can be logical metadata that specifies a context or semantic meaning of the underlying data (or groups of the underlying data). The adaptive query engine 216 can then leverage an interpreter, such as the AI service 226 or a user (e.g., via the client device 202), to perform operations such as selecting among the metadata candidates to identify the data to be used for the response. This scoped context allows the adaptive query engine 216 and its interpreter(s) to converge on a minimal sufficient metadata set for responding to a request without manual technical assumptions.

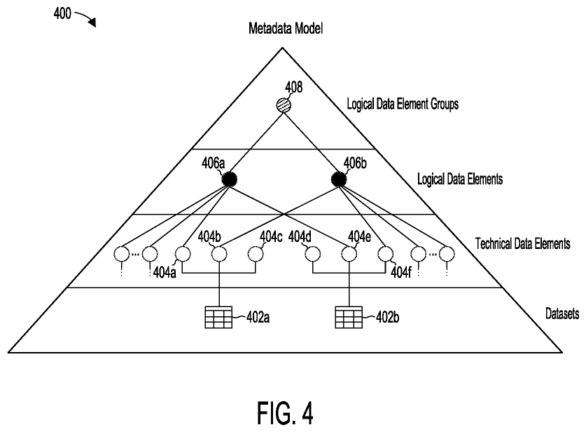

The metadata store 220, which can include one or more hardware storage devices, stores a metadata model 222 and controls 224. The metadata model 222 can include nodes representing items of metadata and edges representing relationships among the nodes, where each node can represent a type or class of metadata such as a logical field name or a technical field name. Additional details on the metadata model are described with reference to FIG. 4. The controls 224 can include technical parameters, business logic, and/or governing protocols configured to regulate the identification, processing, and generation of data. These controls 224 can be defined based on metadata and can include data quality rules (such as accuracy, consistency, and completeness checks), data governance policies (such as security, privacy, and access constraints), and calculation methodologies (such as the commercial or residential VaR formulas). In some examples, the controls 224 can contain any set of rules, logic, conditional statements, or technical standards used to ensure that a result conforms to a set of predefined requirements. In this example, the controls 224 include a commercial value at risk (Comm. VaR) control, a residential value at risk (Res. VaR) control, and a standard deviation (St. Dev.) control.

The environment 210 further includes a data builder 228 configured to perform physical data operations once the appropriate metadata and instructions are identified. The data builder 228 can be implemented as a transformation environment that transforms a logical definition into executable instructions and/or an executable computer program, such as an executable dataflow graph. The data builder 228 can read information from a source data store 230, which can include a set of disparate databases, flat files, or cloud storage buckets. Based on instructions generated through the data resolution engine 212 and the adaptive query workflow 218, the data builder 228 processes data to output a result to an available data store 232 and/or the client device 202 for presentation in the user interface 204. Additional details regarding the use of physical and logical metadata to automatically identify and apply operations on data are described in U.S. Patent Publication No. 2024/0070163, titled “Operationalizing Metadata,” the entire contents of which are incorporated herein by reference.

In this example, the environment 210 depicts an initial stage of the response generation process in which the adaptive query engine 216 identifies a path within the adaptive query workflow 218 to use in responding to the request based on the specific attributes of the request received from the client device 202. Since the request in this example specifies a need for data (e.g., “Please provide the total exposure and value at risk for loans in zip codes 84477, 70859, 60144”), the adaptive query engine 216 identifies a data generation path within the workflow 218 for use in generating the response. Upon selection of the path, the adaptive query engine 216 can provide user interface data to the client device 202 to cause the user interface 204 to display an update (depicted as “Update 1” in FIG. 2B) at Day 1, 2:00:03 pm indicating that the path selection operation has been completed and, in some examples, identifying the selected path.

The technical architecture illustrated in FIG. 2B provides several technical advantages. For example, by utilizing the data resolution engine 212 to automate the orchestration of the adaptive query workflow 218, the system can significantly increase processing speed and reduce operational latency by removing processing bottlenecks. The use of the metadata model 222 and the controls 224 ensures calculation integrity and automated governance by enforcing standardized technical rules (e.g., the correct residential VaR calculation) based on the context of the request, thereby eliminating the risk of unverified technical assumptions. Furthermore, the dynamic view generator 214 provides a technical solution for navigating massive search spaces by surfacing a scoped context of metadata candidates, which enables the AI service 226 or other interpreter to operate within computational context limits while maintaining high precision. The agentic nature of the workflow 218, utilizing multi-agent reviewer patterns, ensures that the system technically converges on a minimal sufficient metadata set without the error-prone manual oversight described in FIG. 1. As shown in FIG. 2B, this configuration removes the active technical effort previously required by a data engineer, QA engineer, and manager, who are shown as external to the active processing loop of the environment 210.

FIG. 2C illustrates an example environment 240 for a field curation operation of a context-driven data identification and generation process. This phase represents a technical progression from the planning operations described in FIG. 2B, occurring at 2:00:10 pm of Day 1. In this example, the adaptive query engine 216 has identified the relevant domain and dataset “island” and proceeds to identify the specific fields needed to satisfy the request.

In this example, the adaptive query engine 216 coordinates with the dynamic view generator 214 to identify relevant fields. The dynamic view generator 214 first analyzes the metadata model 222 within the metadata store 220. As shown in FIG. 2C, the metadata model 222 is annotated with visual indicators to signify the identification of metadata candidates within a previously selected domain (or island). For example, a rounded box encapsulates a set of available datasets within the domain, and a checkmark identifies a specific driving dataset selected during a prior workflow state. Another rounded box encapsulates a set of fields within the metadata model 222 that are related to the fields of the driving dataset, either physically (e.g., via primary or foreign key relationships) or logically (e.g., via associations defined in metadata).

The dynamic view generator 214 uses these identified metadata items to produce a dynamic view of metadata 242. This view identifies the available fields from the perspective of the selected driving dataset. Within the dynamic view of metadata 242, the driving dataset is represented as a table and the associated fields are represented as a set of black circles. Furthermore, the dynamic view generator 214 retrieves a set of controls 224 to produce additional calculated fields within the dynamic view of metadata 242. For instance, the generator 214 can apply a residential value at risk control to append a “Res VaR” calculated field (represented by a specific icon) to the view.

A technical feature of the dynamic view of metadata 242 is the intentional abstraction of relational complexity. While the metadata model 222 includes a set of edges representing complex joins and relationships between datasets, the dynamic view of metadata 242 removes these edges. By presenting the fields in a flattened format without the underlying join logic or relationship edges, the dynamic view generator 214 provides a flattened logical interface. This format prevents an interpreter from having to navigate low-level joining logic, allowing for a more efficient selection based on semantic relevance to the request.

The adaptive query engine 216 then provides the dynamic view of metadata 242 to an interpreter, such as the AI service 226 or a user via the user interface 204. The interpreter evaluates the fields and calculated fields in the view against the natural language intent of the request. For example, the interpreter can perform semantic matching to select a minimal sufficient set of fields, such as property loan values and the calculated residential VaR field, needed for the response. Importantly, because the dynamic view of metadata 242 is a logical representation, this selection is performed as a metadata-only operation without the physical cost of retrieving data from the source data store 230 or executing calculations via the data builder 228.

Once the fields are selected, the adaptive query engine 216 provides data to the client device 202 to update the user interface 204. As shown in FIG. 2C, the user interface 204 displays an execution status update depicted as “Update 5,” indicating the completion of the field curation operation. This update can optionally include an indication of the specific fields selected for the response. In some examples, the dynamic view of metadata 242 can be cached to improve performance and reduce computational overhead for subsequent requests involving similar metadata resolution.

The technical architecture illustrated in FIG. 2C provides several technical advantages. By utilizing a logical dynamic view of metadata 242 that abstracts join complexity, the system simplifies the selection process for the interpreter, leading to faster and more accurate identification of a minimal sufficient field set. Performing this curation at the metadata level avoids the high latency associated with physical data movement and complex joining operations. Additionally, the automated application of controls 224 ensures that the correct governed calculation methodologies are identified and integrated into the response workflow before any physical data processing occurs.

FIG. 2D illustrates an example environment 260 for a data materialization phase of a context-driven data identification and generation process. At this stage, the system shifts from the logical metadata layer to physical data operations to generate a final response to a request.

To initiate the data materialization phase, the adaptive query engine 216 uses the minimal sufficient set of metadata identified in previous phases (and, in some examples, a declarative specification for this metadata) to plan physical execution. The system leverages the context of the request and the underlying metadata model 222 to ground the request appropriately. This grounded logical context is then provided to the data builder 228 to generate execution instructions.

The data builder 228 operates as a transformation and execution environment configured to convert the logical metadata parameters into executable instructions. To perform this transformation, the data builder 228 can traverse the metadata model 222 to identify technical metadata corresponding to the logical metadata identified during the field curation and selection processes. Using this technical metadata, the data builder 228 can link the logical fields to specific items of physical data, physical schema definitions, or data access protocols within the source data store 230. The data builder 228 then uses the technical metadata to generate a set of executable instructions, technical logic, or an executable computer program (e.g., an executable query, a script, or a dataflow graph) configured to perform the sequence of physical data operations. Additional details regarding transforming a definition or specification into an executable computer program are described in U.S. Patent Publication No. 2019/0130048, titled “Transforming a Specification into a Persistent Computer Program,” the entire contents of which are incorporated herein by reference.

Once the instructions are compiled and generated, the data builder 228 executes the instructions to read physical data from the source data store 230. During execution, the data builder 228 applies the specified technical logic and governance rules curated in the logical phase to calculate and materialize the data physically. Because the request was properly grounded using the metadata model 222, the data builder 228 automatically executes the correct calculation methodology, such as applying a residential VaR control rather than a commercial VaR control. This automated, context-aware execution ensures that the correct calculation is utilized, avoiding the assumption-based errors and technical mismatches shown in FIG. 1.

Upon completing the physical execution, the data builder 228 outputs the requested data 262. The data builder 228 can store the requested data 262 in an available data store 232 for subsequent access or downstream processing. Additionally, the requested data 262 is provided to the client device 202 to be rendered in the user interface 204. For instance, the user interface 204 can display the requested data 262 to a residential business analyst, fully satisfying the initial natural language request. As illustrated by the temporal baseline of Day 1, 2:00:15 PM, the requested data 262 is provided only 15 seconds after the initial request was made.

The technical architecture illustrated in FIG. 2D provides several technical advantages. First, the system achieves a drastic reduction in operational latency by automating the architectural workflow, successfully compressing the 120-day manual, error-prone process depicted in FIG. 1 into a 15-second automated resolution. Second, automated metadata governance ensures calculation integrity. By structurally enforcing the correct technical rules at execution based on metadata model traversal, the system eliminates human assumption errors and calculation mismatches. Ultimately, this configuration provides a robust end-to-end automation environment that effectively bridges the gap between natural language intent and physical data materialization without requiring intervention from data engineers or quality assurance personnel.

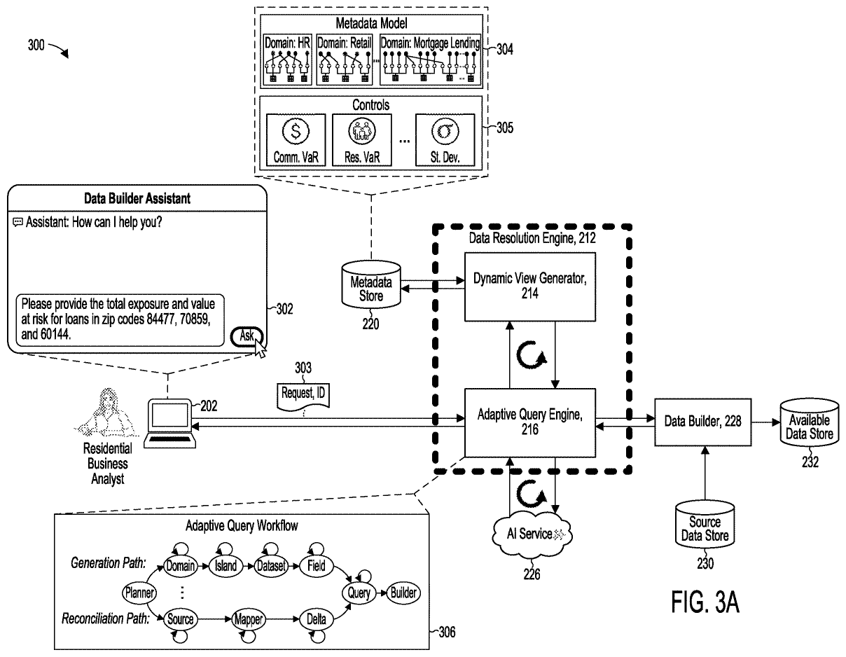

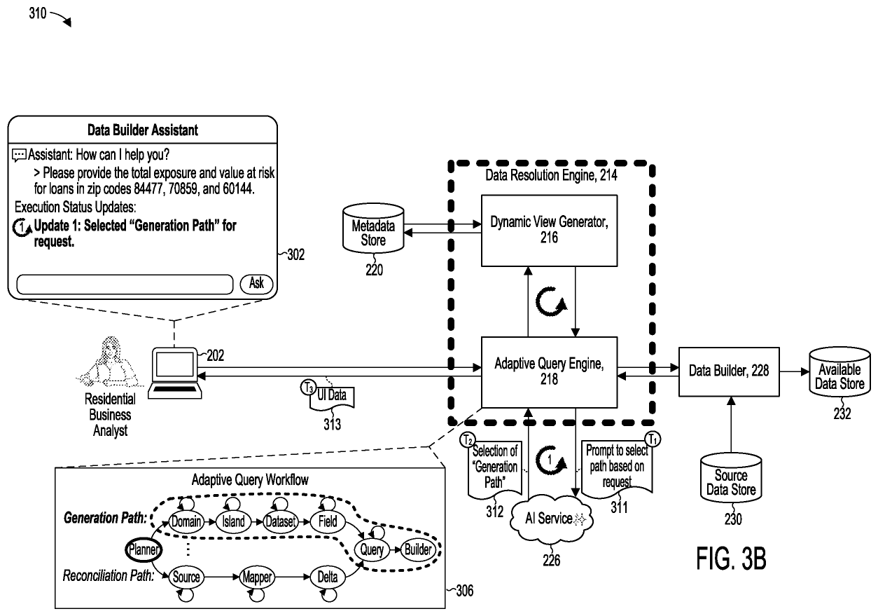

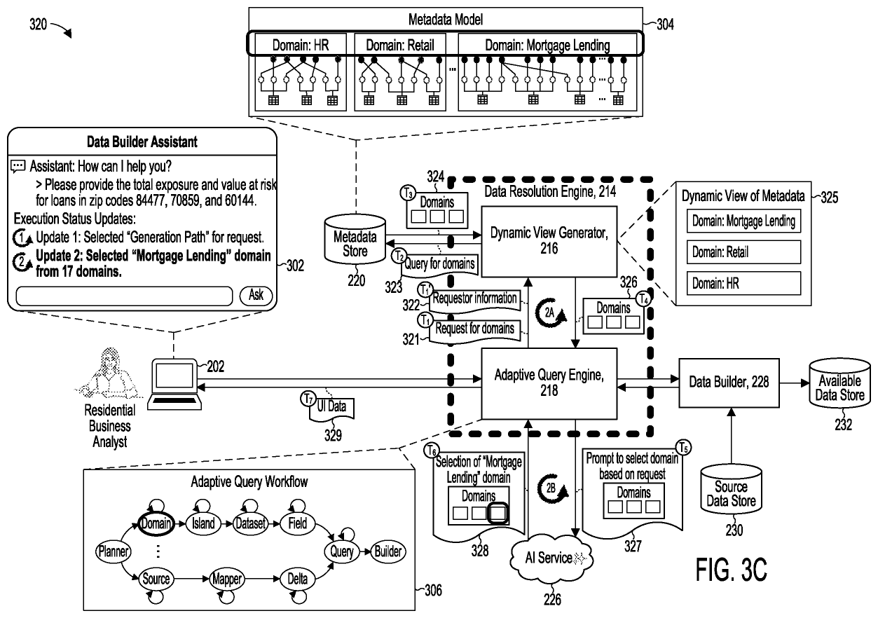

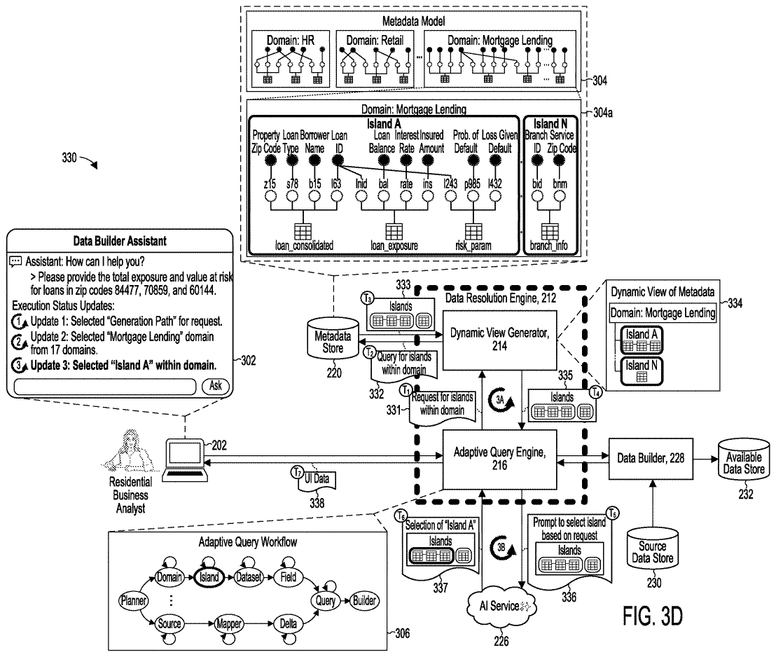

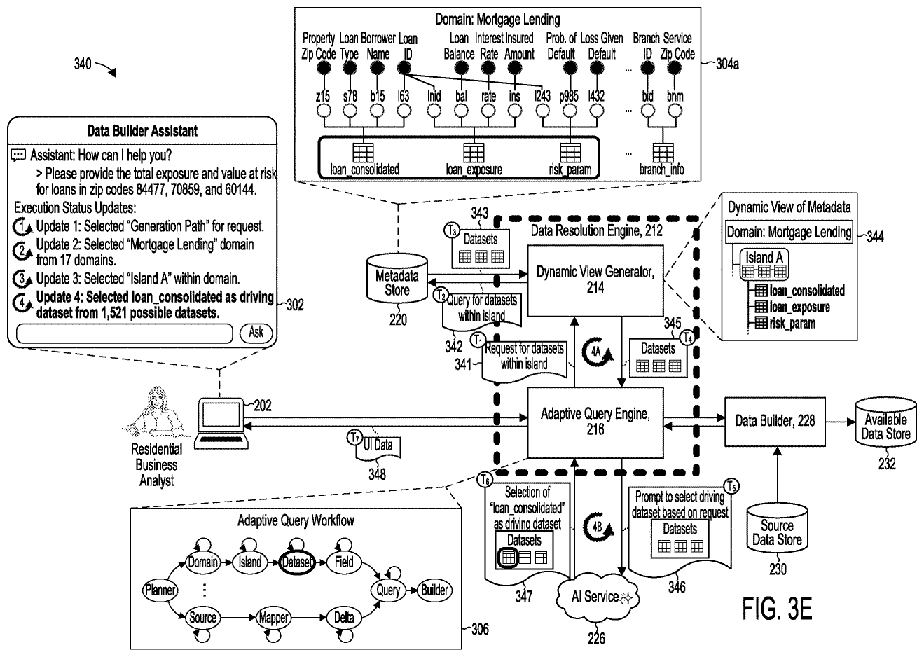

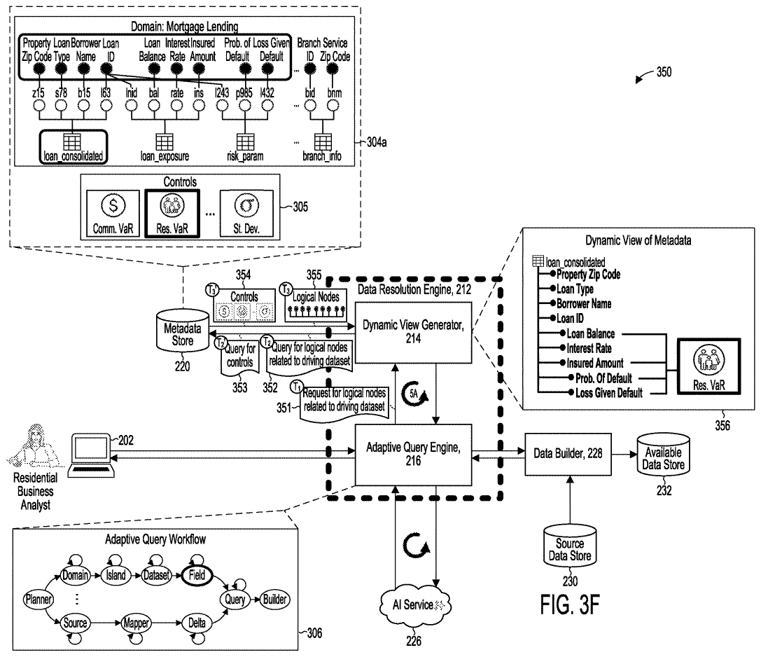

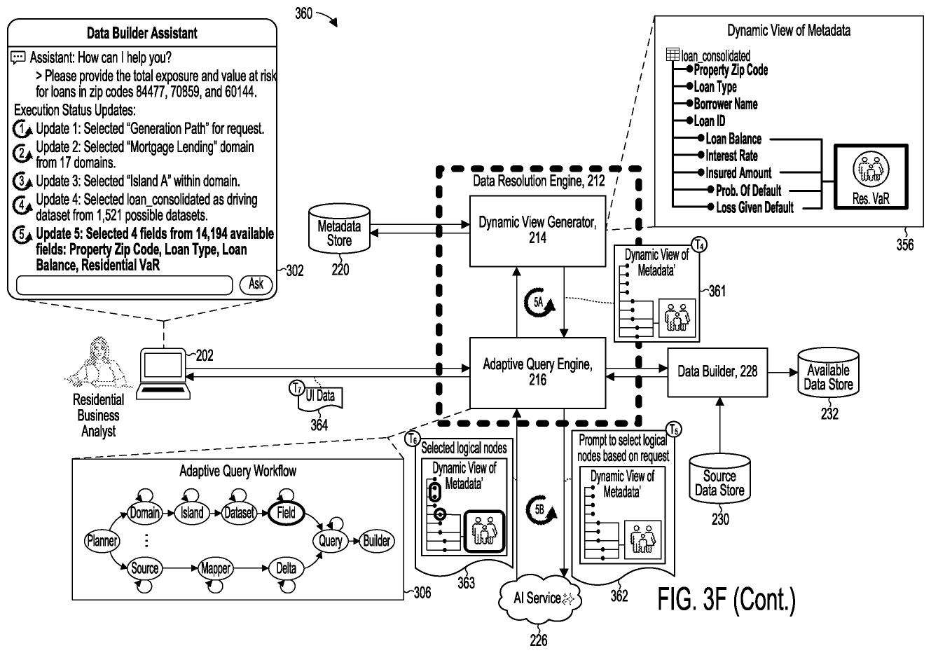

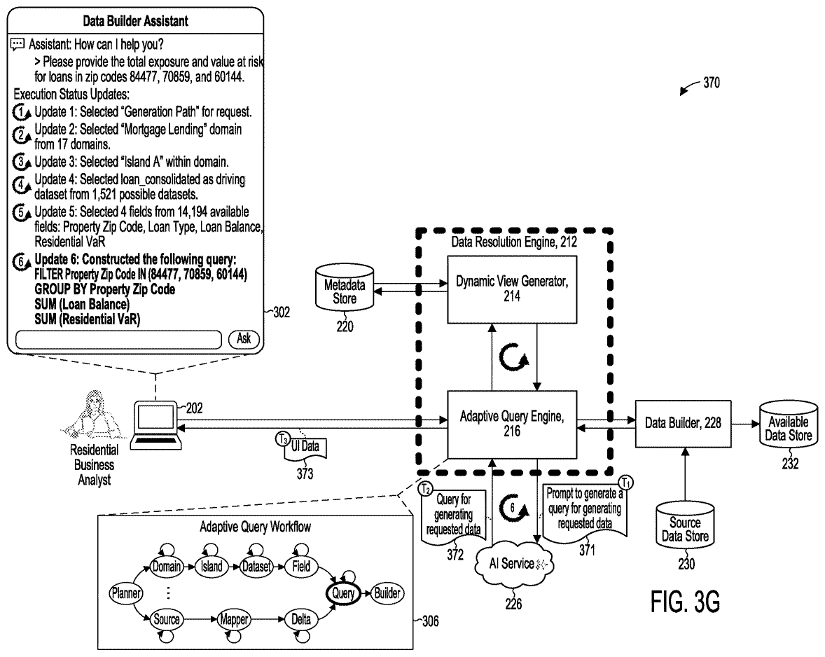

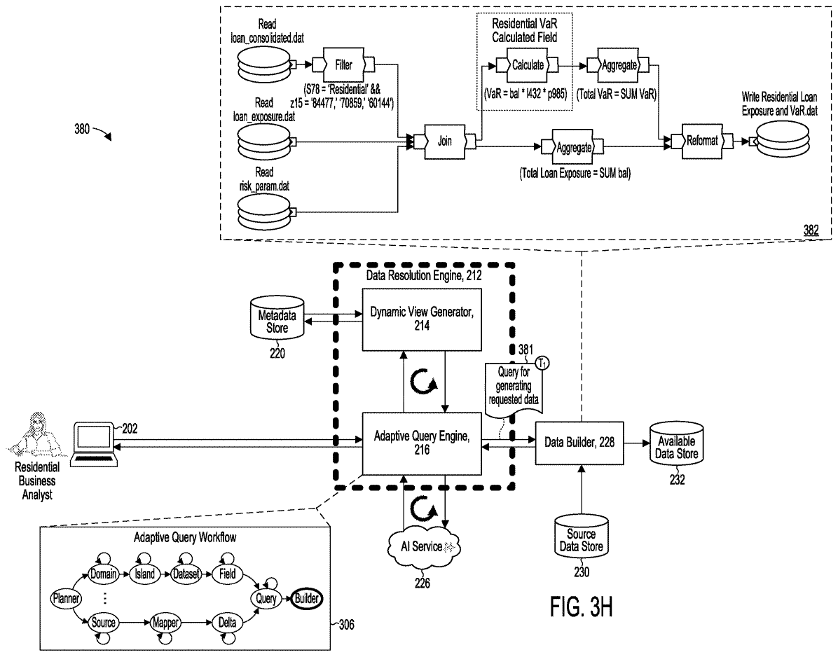

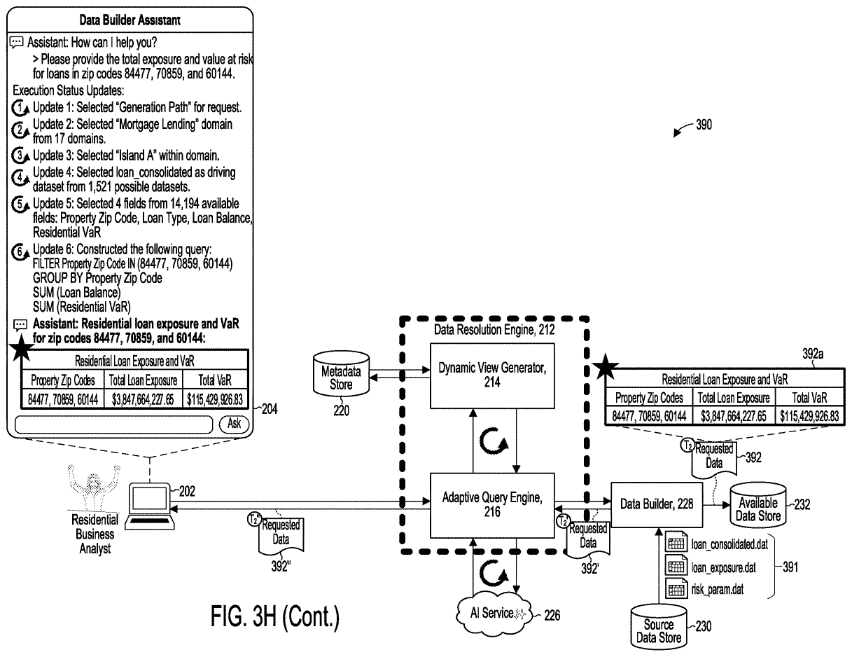

FIG. 3A illustrates an example environment 300 for receiving a request and determining contextual information as part of a context-driven data identification and generation process. The environment 300 shares similarities with previously described architectures, and certain corresponding details are omitted here for brevity. In this implementation, a user, such as a residential business analyst, can utilize a client device to submit a request 303 for data via a data assistant UI 302. For example, the user can input a natural language query, such as “Please provide the total exposure and value at risk for loans in zip codes 84477, 70859, and 60144,” into the data assistant UI 302. Upon submission, the request 303 is transmitted to the data resolution engine 212.

In some examples, to facilitate an accurate technical response, the request 303 includes an identifier, such as a user ID, a session ID, or an authentication token. The data resolution engine 212 uses this identifier to automatically determine contextual information for the request 303. For example, the data resolution engine 212 can use the identifier to ground the request 303 contextually, automatically resolving that the user belongs to a specific business unit, such as a residential division rather than a commercial division. This contextual grounding can also include determining a navigation context based on the user interface location specified by the request. Establishing this contextual information allows the data resolution engine 212 to technically restrict or guide subsequent metadata resolution, ensuring the system searches only within the appropriate technical boundaries.

The environment 300 further introduces an expanded metadata model 304 and a set of controls 305. The metadata model 304 includes a structured logical representation of multiple distinct business or technical domains. As illustrated in FIG. 3A, the metadata model 304 is partitioned to include a “HR” domain, a “Retail” domain, and a “Mortgage Lending” domain. Each domain within the metadata model 304 contains a set of nodes and edges representing the specific datasets, physical relationships, and logical relationships relevant to that area. Furthermore, the set of controls 305 (e.g., commercial VaR, residential VaR, and standard deviation) functions similarly to previously described parameters to regulate data quality and calculation methodologies.

To coordinate the resolution of the request 303 against the metadata model 304, the data resolution engine 212 utilizes a detailed adaptive query workflow 306. While consistent with previously described orchestrations, the adaptive query workflow 306 provides a more detailed, multi-stage sequence of operations modeled as a state machine. As shown in FIG. 3A, the adaptive query workflow 306 includes a planner component that initiates distinct execution paths, such as a generation path and a reconciliation path. The generation path specifies a set of operations (e.g., agentic steps or evaluation criteria), including a domain stage, an island stage, a dataset stage, a field stage, a query stage, and a builder stage. Additionally, the reconciliation path includes a source stage, a mapper stage, and a delta stage. Each stage within the adaptive query workflow 306 requires the satisfaction of specific criteria before the data resolution engine 212 can progress the state of the response.

The technical architecture illustrated in FIG. 3A provides a number of technical advantages. By executing automated contextual grounding via the identifier in the request 303, the system eliminates the need for users to manually define their technical scope or domain, reducing human error and preventing out-of-scope computational queries. Additionally, the detailed adaptive query workflow 306 provides deterministic orchestration for the resolution process. This highly structured, replicable state machine prevents interpreter hallucination by forcing the data resolution engine 212 to navigate the resolution process through a set of strictly governed, sequential checkpoints.

FIG. 3B illustrates an example environment 310 for a planning phase of the context-driven data identification and generation process. This figure depicts a multi-step dataflow in which a system evaluates a natural language request to dynamically route execution through an optimal path within an adaptive query workflow 306.

To initiate the sequence, the adaptive query engine 218 generates and transmits a prompt 311 to an interpreter, such as the AI service 226. The prompt 311 is configured to instantiate a planner AI agent. This prompt 311 instructs the AI service 226 to evaluate the semantic intent of the request against the available technical capabilities mapped within the adaptive query workflow 306. To ensure accurate routing, the prompt 311 can include the natural language request, an identified strategy, and contextual information describing a metadata model.

Following this evaluation, the AI service 226 executes a selection 312 of a generation path based on the prompt 311. As visually depicted by the dashed boundary lines in FIG. 3B, this selection locks the system into executing a specific sequence of stages encompassed within the generation path, including a Domain stage, an Island stage, a Dataset stage, a Field stage, a Query stage, and a Builder stage. These stages represent a deterministic pipeline where the Domain stage scopes the request to a specific business topic cluster, and the Island and Dataset stages execute entity resolution to select a collection of related datasets and a specific driving dataset. Subsequently, the Field stage curates and compresses the available fields to a minimal sufficient set, allowing the Query and Builder stages to construct a declarative specification and map the curated fields to precise technical operations.

Upon successfully locking in this path, the adaptive query engine 218 transmits a user interface update, depicted as UI data 313, to the client device 202 to update the data assistant UI 302. This update renders a visual indicator or status message in the data assistant UI 302 informing the user that the planning phase has concluded and the generation path has been actively selected.

FIG. 3C illustrates an example environment 320 for a domain selection phase of the context-driven data identification and generation process. This phase scopes a user query to a data domain, such as a conversational domain or a semantic cluster. Scoping the query reduces the metadata context from the full organizational catalog to a focused subset, enabling downstream interpreters to operate within context limits. Ultimately, this phase transforms a generalized data inquiry approach into a two-stage retrieval process that executes domain selection, followed by dataset selection within the domain.

Initially, the adaptive query engine 218 transmits a request for domains 321 and requestor information 322 (e.g., the requestor ID and/or contextual information derived from the requestor ID) to the dynamic view generator 214. In response, the dynamic view generator 214 queries the metadata model 304 of the metadata store 220 for available domains. Additional details regarding querying or otherwise obtaining metadata from metadata models are described in U.S. patent application Ser. No. 18/885,179, titled “Metadata Change Triggers,” the entire contents of which are incorporated herein by reference.

The metadata store 220 returns a set of domains 324 to the dynamic view generator 214. The returned domains 324 can include domain names, descriptions, and composite identifiers. The dynamic view generator 214 can generate a dynamic view of metadata 325 including the available domains (e.g., Mortgage Lending, Retail, and HR) and can provide the available domains 326 (e.g., via the dynamic view 325 or a list) to the adaptive query engine 218.

The adaptive query engine 218 generates and transmits a prompt 327 to an interpreter, such as the AI service 226, to select a domain based on the request. In general, the prompt 327 can provide the request, a formatted list of domains, and optional feedback if the system is executing a retry loop. In some examples, the prompt 327 instantiates a domain AI agent configured to select the domain from the available domains. The prompt 327 can utilize a specific strategy, including a system prompt that defines matching principles (e.g., matching by entities mentioned, business processes, or analytical metrics) alongside a number of examples.

In this example, the AI service 226 evaluates the prompt 327 and executes a selection 328 of the “Mortgage Lending” domain. To keep the schema simple and encourage exact matches, the output format can be restricted to strictly outputting the domain name, without providing the underlying reasoning. Following this output, the system can validate the domain object by name and store the chosen domain in a workflow state.

If the selection is successful, the adaptive query engine 218 prepares the control flow to fetch dataset islands, as discussed with respect to FIG. 3D. Alternatively, if there is an error associated with the selected domain (e.g., the domain name is invalid), the adaptive query engine 218 can retry the domain selection process with feedback for a set number of attempts (e.g., a maximum of 3 attempts). In some examples, if downstream entity resolution fails, the control flow can return to this domain resolution phase. In some examples, a fixed domain mode can bypass this selection entirely and flow directly to entity resolution. Once selected, the adaptive query engine 218 can transmit UI data 329 to the client device 202. The UI data 329 renders a visual status update in the data assistant UI 302 informing the user of the resolved state, such as “Update 2: Selected ‘Mortgage Lending’domain from 17 domains”.

The architecture illustrated in FIG. 3C provides a number of technical advantages. Scoping the query to a specific conversational domain reduces the metadata context from a full organizational catalog to a focused subset, enabling downstream operations and interpreters to operate efficiently within context limits. This scoping also helps prevent hallucination or information overload during subsequent entity resolution steps, as the AI service 226 (or another interpreter) is technically constrained to a known, curated metadata boundary. Additionally, this domain selection drastically improves system accuracy and token efficiency. Because subsequent interpreter prompts contain only relevant subsets of metadata rather than the entire organizational repository, the system conserves token bandwidth and reduces computational overhead. Furthermore, transmitting the UI data 329 provides continuous system transparency, keeping the user informed of the precise logical boundaries the system has established before deeper data scanning occurs.

In some examples, retrieval-augmented generation on-the-fly over datasets and data elements within each domain can be used to automatically generate domains and their associated names and descriptions. By persisting embeddings in a vector store, domain descriptions remain dynamically updated as datasets are added or removed. The architecture can also leverage business entity constructs for semantic indexing of driving datasets, providing richer business context than dataset-level metadata alone. Additionally, the single agent implementation can evolve into a subgraph configured to loop internally, explore multiple candidate domains in parallel, and provide confidence scoring for domain selection to enable sophisticated error recovery and ambiguous query handling. Finally, for high-level queries that use data from multiple domains (e.g., assessing trends across mortgage, credit card, and deposit portfolios), the architecture can support multi-domain parallelization. This allows parallel workflow execution across multiple domains independently, gathering and synthesizing the results to successfully process queries that span business topics without being restricted by cross-domain join limitations.

FIG. 3D illustrates an example environment 330 for a domain island selection phase of the context-driven data identification and generation process. A domain island is a set of related (e.g., physically and/or logically interconnected) data within a domain.

To initiate the selection, the adaptive query engine 216 transmits a request for islands within the selected domain 331 to the dynamic view generator 214. The dynamic view generator 214 formulates a query for islands within domain 332 and transmits it to the metadata store 220. Following the retrieval, the metadata store 220 returns the identified islands 333. These domain islands can be computed by, e.g., traversing physical and/or logical key relationships to identify interconnected islands within the domain. The dynamic view generator 214 constructs a dynamic view of metadata 334 containing the available islands 335, such as Island A and Island N, and provides them to the adaptive query engine 216. If only a single domain island exists, the system can automatically select it; otherwise, the system can invoke an interpreter (e.g., a selector agent).

In operation, the adaptive query engine 216 generates and transmits a prompt 336 to select island based on request to an interpreter, such as the AI service 226. The prompt 336 can include the request, a formatted list of domain islands including names, descriptions, and structure, and feedback if retrying. The prompt 336 can emphasize semantic matching, aligning with entities and concepts in the request, rather than keyword matching. In some examples, the prompt 336 can instruct a liberal approach, preferring broader coverage and indicating it is better to try a domain island and learn it is incorrect than to reject it prematurely.

Based on the prompt, the AI service 226 evaluates the information and outputs a selection of “Island A” 337. For example, the interpreter may analyze the request for entities, such as “exposure” and “value at risk,” and evaluate the domain islands to find the one relevant to both loan balance and value at risk data. In some examples, this output is an index-based selection, such as a tree index, which keeps the schema simple and enables validation. If the selection is successful, the system advances to a driving dataset selection phase, as described with reference to FIG. 3E. On the other hand, if there are errors with the domain island selection (e.g., if the selected index is invalid), the system can retry with feedback. If no domain island is suitable, the system returns an error to the parent workflow (e.g., domain selection). Upon a successful selection, the adaptive query engine 216 transmits UI data 338 to the client device 202 to render a status update in the data assistant UI 302, such as “Update 3: Selected ‘Island A’ within domain.”

The two-stage approach of resolving domains and then domain islands provides a number of immediate technical advantages. This process leverages knowledge graph structures, enabling semantic reasoning over dataset relationships rather than requiring the agent to understand low-level join mechanics. Additionally, the liberal prompt approach reduces false negatives.

In some examples, the system can scope the fetch tree to only return domain islands that the user has permission to query based on access grants, which improves governance and performance. The system can also maintain a retry history in a workflow state, enabling agents to reason about the entire solution space and aggregate feedback across retries rather than just viewing the most recent failure. Furthermore, the sequential process can evolve into a subgraph that evaluates multiple candidate domain islands simultaneously to handle ambiguous queries through parallel exploration.

FIG. 3E illustrates an example environment 340 for a driving dataset selection phase of the context-driven data identification and generation process. Within the previously chosen domain island, this phase identifies which dataset serves as the starting point or perspective for responding to the request. A driving dataset establishes the query's starting point and determines the result grain (e.g., “one row per customer” versus “one row per transaction”), functioning similarly to a FROM clause in a SQL statement.

To initiate the sequence, the adaptive query engine 216 transmits a request 441 for datasets within island 341 to the dynamic view generator 214. The dynamic view generator 214 formulates a query for datasets within island 342 and transmits it to the metadata model 304. Following this query, the metadata model 304 returns the identified datasets 343 to the dynamic view generator 214. The dynamic view generator 214 constructs a dynamic view of metadata 344 containing the available datasets 345 (e.g., loan_consolidated, loan_exposure, and risk_param) and provides them to the adaptive query engine 216.

Following the retrieval of the available datasets 345, the adaptive query engine 216 constructs and transmits a prompt 346 to select driving dataset based on request to an interpreter, such as the AI service 226. In some examples, this prompt invokes the AI service 226 to act as a driving dataset selector agent. The prompt 346 can include the initial request, a formatted list of datasets within the selected domain island (including dataset names, descriptions, and composite IDs), and optional feedback if retrying. The system prompt can leverage a SQL FROM clause analogy or other instructions to enable the interpreter to identify the core entity in the request. This core entity represents the main subject being counted, filtered, or aggregated, and the interpreter operates with the understanding that other datasets will automatically be joined via foreign keys.

For example, for the request “Please provide the total exposure and value at risk for loans in zip codes 84477, 70859, and 60144,” the interpreter can identify that the request requires calculating exposure and value at risk at the loan level, filtered by specific geographic attributes. Using the SQL analogy, the driving dataset is the loan (one row per loan to aggregate the exposure and value at risk metrics). Because this core entity corresponds to the loan_consolidated dataset within the domain island, the interpreter selects loan_consolidated as the driving dataset, with the understanding that related datasets containing specific zip code data or risk parameters will automatically be joined in later to facilitate the filtering and calculations.

Upon evaluating the prompt 346, the AI service 226 outputs a selection of “loan_consolidated” as driving dataset 347. In some examples, rather than merely outputting a dataset name, this output includes a composite ID for the dataset (e.g., “262.1001”). If the selection is successful, the selection (e.g., composite ID) is passed forward, and control flows to a field curation phase shown in FIG. 3F. If there are errors with the selected driving dataset (e.g., composite ID is invalid), the system can retry with feedback. If no suitable dataset is found within the domain island, control returns to the previous island selection phase after a maximum of 3 internal retries for reconsideration. Upon a successful selection, the adaptive query engine 216 transmits UI data 348 to the client device 202. The UI data 348 renders a visual status update in the data assistant UI 302, such as “Update 4: Selected loan_consolidated as driving dataset from 1,521 possible datasets,” informing the user of the selected driving dataset.

The illustrated driving dataset selection phase provides a number of technical advantages. Utilizing the SQL FROM clause analogy leverages a familiar mental model that helps the interpreter reason structurally about the query. Furthermore, outputting a composite ID can ensure precise identification within the metadata hub. Presenting datasets as independent entities at this stage ensures the agent focuses solely on driving dataset semantic identification rather than getting confused by relationship traversal mechanics.

In some examples, the system can analyze the relationship topology within a domain island, operating on the principle that a better driving dataset typically sits at a one-to-many junction (e.g., Customer to many Accounts) rather than a many-to-one junction. By traversing foreign key relationships and analyzing cardinality, the system can recommend or constrain the driving dataset selection to entities that make structural sense as query foundations. This topology-based analysis can reduce errors where an interpreter might inappropriately select a child entity when the parent entity is required for the aggregation level of the query.

FIG. 3F and FIG. 3F (Cont.) illustrate example environments 350, 360 for a field selection phase of the context-driven data identification and generation process. The primary goal of this phase is to identify the minimum set of logical fields for generating a response to the request. In some instances, text-to-SQL approaches need complete table schemas even for intermediate joins, causing context to massively increase and breaking down agent workflows. To address this, the techniques described herein can create a flattened field tree, sometimes referred to as a wide record, representing all accessible fields across related datasets, and surgically curates this tree down to a minimum sufficient set of relevant fields (e.g., reducing hundreds of thousands of fields to a minimal set, yielding up to a 99% or more reduction). Additional details regarding the generation of expanded view datasets and wide records across related datasets are described in U.S. Patent Publication No. 2024/0320224, titled “Logical Access for Previewing Expanded View Datasets,” the entire contents of which are incorporated herein by reference.

Referring to FIG. 3F, to initiate the sequence within the environment 350, the adaptive query engine 216 transmits a request for logical nodes related to driving dataset 351 to the dynamic view generator 214. In response, the dynamic view generator 214 formulates and transmits a query for logical nodes related to driving dataset 352 and a query for controls 353 to the metadata store 220. The metadata store 220 then returns the identified controls 354 and logical nodes 355. Following this retrieval, the dynamic view generator 214 can supplement the logical fields with calculated logical fields determined by applying the specific controls 354. For example, a calculated field like “Residential VaR” can be generated based on underlying logical nodes (e.g., Loan Balance, Loss Given Default, and Probability of Default) associated with the returned controls 354. The dynamic view generator 214 can then generate a comprehensive dynamic view of metadata 356 representing all available fields.

Transitioning to the operations in the environment 360 illustrated in FIG. 3F (Cont.), the adaptive query engine 216 receives a version of the dynamic view of metadata′ 361. The system then leverages an interpreter to select fields within the available fields. In some examples, the system implements an iterative refinement subgraph utilizing multiple (e.g., three) distinct agents. First, the adaptive query engine 216 formulates and transmits a prompt to select logical nodes based on request 362 to an interpreter, such as the AI service 226, invoking a field selection agent. This agent processes datasets in parallel and enforces extreme minimalism, defaulting to an EXCLUDE action and including fields solely if useful for operations like filtering or grouping. Next, the system invokes the interpreter acting as a mini data architect agent that maps the selected fields to planned operations, such as SELECT, FILTER, HAVING, AGGREGATION, GROUP BY, and CALCULATION. This mapping forces a burden of proof, prompting the agent to explicitly justify how each field will be used to prevent casual or unnecessary field addition.

Finally, a reviewer agent evaluates the mapped fields. To prevent scope creep, the reviewer agent exclusively evaluates the selected fields rather than the full tree, and it validates whether the planned operations can sufficiently answer the query. If incomplete, the reviewer agent generates structured conceptual feedback including KEEP, REMOVE, and ADD directives, initiating an iteration loop (e.g., up to a maximum of 3 iterations). For example, for the request “please provide the total exposure and value at risk for loans in zip codes 84477, 70859, and 60144,” the first iteration can correctly select exposure and value at risk fields for aggregation, alongside a zip code field for filtering, but miss a display operation. The reviewer agent marks this incomplete and provides feedback indicating the need to actually display the calculated results and the associated zip codes. During a second iteration, the system adds a SELECT operation for the display fields. Upon successful completion, the AI service 226 outputs the selected logical nodes 363. The adaptive query engine 216 then transmits UI data 364 to the client device 202, rendering a visual status update in the data assistant UI 302, such as “Update 5: Selected 4 fields from 14,194 available fields,” to inform the user of the curated selection.

The illustrated architecture provides a number of technical advantages. Context compression enables the system to scale and handle massive field trees while remaining within the context limits of large language models. Furthermore, the multi-agent architecture utilizes a reviewer pattern that separates an actor or writer from a critic or judge. This structure effectively balances the chronic over-selection of “filtration down” approaches against the under-selection of “selection up” approaches by enforcing disciplined justification and strict quality gates.

In some examples, for massive datasets containing hundreds of fields (e.g., greater than 100 fields), the system can implement hierarchical field selection. This involves partitioning fields into subsets, executing parallel selection on each partition, combining the results, and conducting a dataset-level review to prevent agents from over-selecting when overwhelmed by context. The architecture can also incorporate a field metadata enrichment tool to provide agents with dynamic code values or null handling semantics. Finally, reviewer agent confidence scoring can be introduced to enable nuanced routing, such as automatically proceeding for high-confidence selections or triggering human-in-the-loop workflows for low-confidence incomplete results.

FIG. 3G illustrates an example environment 370 for a declarative specification generation phase of the context-driven data identification and generation process. This phase translates a natural language query and a curated field list into a declarative specification that a downstream data builder can use to generate requested data.

In some examples, because of prior data curation phases, the interpreter operates on a radically simplified problem space. For example, the interpreter can focus solely on mapping a minimal set of curated fields (e.g., 3 to 10 fields instead of over 150 fields) to operations without worrying about complex join logic or topology traversal, which a downstream data builder handles automatically. The specification format includes six atomic operations: SELECT, FILTER, AGGREGATION, GROUP BY, CALCULATION, and HAVING. These operations can be compositional, order-independent, and based on structured SQL expressions.

To initiate the sequence, the adaptive query engine 216 formulates and transmits a prompt to generate a query for generating requested data 371 to an interpreter, such as the AI service 226. This can invoke a query draft agent to produce an initial draft of the specification. The query draft agent optimizes for coverage over perfection, utilizing a field tree enriched with code values, business types, common values, and child field flags. Following the draft generation, the system can invoke a query refinement agent to refine the draft specification. The query refinement agent fixes structural issues, enforces canonical formats, and translates business terms into database codes using the enriched metadata. During these drafting and refinement operations, the agents rely on a composite ID convention, working with formatted identifiers (e.g., {264.1001}) rather than technical names.

Following the refinement, a query reviewer agent can evaluate the refined query against the intent of the user. The query reviewer agent validates completeness and makes a routing decision. For example, the query reviewer agent can approve the query for execution, request a revision to iterate on the draft up to a maximum of two times, or request more fields if iterations are exhausted. For example, for the request “please provide the total exposure and value at risk for loans in zip codes 84477, 70859, and 60144,” the agent(s) can map operations by assigning AGGREGATION operations to sum the total exposure and the value at risk, alongside a FILTER operation for the specified zip codes. The query refinement agent applies canonical formatting for the zip codes (e.g., properly quoting them as strings) and can translate business terms like “value at risk” into the database codes used by the downstream data builder. The query reviewer agent then approves the specification because it matches the request without including unnecessary operations. Before exiting the phase, the system can translate the composite IDs into technical names (e.g., swapping an ID like {264.2010} for loan.original_loan_amount) so it is ready for processing by the downstream data builder. The AI service 226 outputs a query for generating requested data 372. Finally, the adaptive query engine 216 transmits UI data 373 to the client device 202 to render a visual update in the data assistant UI 302, such as “Update 6: Constructed the following query,” indicating the successful query generation.

The declarative specification generation phase provides a number of technical advantages. By utilizing a composite ID convention, the system simplifies agent reasoning and enables deterministic validation without requiring the agents to understand complex naming conventions or path traversal. Furthermore, separating concerns across a pipeline of specialized agents (e.g., drafting for coverage, refining for structure and formatting, and reviewing for quality assurance) can reduce iteration cycles and prevents execution errors. Additionally, generating operations that are order-independent makes the resulting specification highly compositional and adaptable during iterative refinement.

In some examples, the architecture can branch to specialized interpreters, or agents, per operation type, such as a FILTER specialist or an AGGREGATION specialist, invoking agents in parallel per operation to maximize metadata context for each specific decision. Another variation can include supporting iterative refinement on intermediate query results. In this approach, complex queries can be broken into sequential subqueries, materialized into intermediate tables, and used to inform the next stage, such as calculating an overall average first and then using that result to filter specific cities. In some examples, an extended parser can be implemented to support arbitrary SQL complexity, allowing the system to handle subqueries, window functions, complex conditionals like CASE statements, and set operations like UNION.

In some examples, the system can implement an error analysis phase to handle execution failures resulting from the declarative specification. When a downstream execution engine returns an error based on a generated specification, an error analysis agent examines the error message, the user request, the constructed specification, and available fields to diagnose a root cause. Rather than surfacing raw errors to interpreters or indiscriminately restarting a workflow, the error analysis agent can execute a targeted routing classification. For example, the agent can route control back to the data curation phase if the error indicates missing or incorrect fields, or back to the data architect phase if the error involves query logic issues such as type mismatches, naming issues, or aggregation problems. This targeted routing preserves work from correctly functioning upstream steps. To prevent infinite loops, the system can maintain separate retry counters, such as a field retry counter and a query retry counter, allowing a specific maximum number of correction attempts.

For example, consider a request to “Show loans with original amount greater than 500000.” If the generated specification includes a filter using a string comparison for a decimal field, the execution engine can return a type mismatch error. The error analysis agent examines the metadata, identifies that a numeric literal is expected instead of a string literal, increments the query retry counter, and routes the workflow back to the data architect with specific error feedback so the string can be corrected. Advanced implementations of this error analysis phase can include a diagnostic subgraph configured to author and execute diagnostic common table expressions to validate assumptions about the cause of an error before routing. Furthermore, the system can utilize a structured error taxonomy where the execution engine returns typed error codes (e.g., ERROR_TYPE_MISMATCH) mapped to specific recovery actions, reducing reliance on raw text analysis.

Additionally, or alternatively, the system can implement a data review phase to validate that retrieved data successfully answers the original query before formatting a final output. Rather than automatically presenting retrieved results, a data review agent evaluates the structure, completeness, and correctness of the data against the intent of the user. The data review agent examines a preview of the returned data alongside the query specification and routes the workflow to one of three outcomes. If the data successfully answers the query, the agent routes control to a final data output phase. If critical fields are missing, the agent routes control back to the data curation phase. If operations are incorrect or the data structure is misaligned, the agent routes control back to the data architect phase.

For example, consider a request “How many loans do we have in San Francisco?” This request is for a count aggregation returning a single row. If the data architect omits the aggregation operation, the executed query can return thousands of individual loan records. The data review agent detects this structural mismatch between the detailed data and the requested count, increments a retry parameter, and routes the workflow back to the data architect to add the appropriate aggregation operation. To handle more complex anomalies, advanced implementations of the data review phase can utilize a diagnostic subgraph configured to iteratively probe the data, test relaxed filter conditions, or sample dataset distributions to investigate unexpected responses. Other enhancements can include confidence scoring for routing decisions, pattern matching against common query antipatterns (e.g., executing a count operation without grouping on a multi-value dimension), and leveraging execution metadata, such as row counts and execution times, as signals for anomaly detection.

FIGS. 3H and 3H (Cont.) illustrate example environments 380, 390 for a data builder phase and a subsequent execution phase of the context-driven data identification and generation process. These phases transform a declarative specification into executable instructions, such as an executable dataflow graph, and produce requested data and format that data into a structured response.

Referring to FIG. 3H, to initiate the data builder phase, the adaptive query engine 216 transmits a query (e.g., declarative specification) for generating requested data 381 to the data builder 228. In this example, based on this specification, the data builder 228 constructs an executable dataflow graph 382. The dataflow graph 382 includes nodes or vertices representing components, such as data files or computational processes, and edges representing the flows of data between these components. Additional details regarding systems for executing such graph-based computations are described in U.S. Pat. No. 5,966,072, titled “Executing Computations Expressed as Graphs,” the entire contents of which are incorporated herein by reference. To realize the declarative specification, the data builder 228 generates specific operational nodes within the dataflow graph 382. For example, the data builder 228 translates FILTER and AGGREGATION operations from the specification into corresponding executable processing nodes that filter the data by the specified zip codes and aggregate the total exposure. In constructing this graph, the data builder 228 leverages metadata from the metadata store 220 to automatically handle complex operations. For example, joins and calculated fields are defined directly in the metadata, and logic from control nodes is leveraged during the generation process. Specifically, to accommodate the calculated logical field for the Residential VaR requested during the field selection phase, the data builder 228 retrieves the underlying logic defined in the corresponding control and inserts it as a distinct computational node directly into the dataflow graph 382. This ensures the correct calculation of the value at risk is executed dynamically as data flows through the graph.

Following the generation of the dataflow graph 382, the sequence transitions to the execution and output phase illustrated in the environment 390 of FIG. 3H (Cont.). An execution engine associated with the data builder 228 processes the dataflow graph 382 against data within the source data store 230 to generate raw dataset files 391, such as loan_consolidated.dat, loan_exposure.dat, and risk_param.dat. In some examples, before the raw data is formatted for the user, the system can invoke a data review subgraph to investigate unexpected responses. Upon detection of a mismatch between the data and the request, the data review agent can route the workflow back to the data architect for correction. Once the query is corrected and re-executed, the data review agent approves the resulting data.

Upon successful review, the workflow proceeds to a data output operation. A presentation agent can transform the raw, approved query results into requested data 392, structured as a user-friendly output 392a. The presentation agent utilizes markdown formatting to organize the response into logical sections, including a summary answer, a data table, and key insights. During this formatting, the agent can reorganize the data by adding currency symbols, calculating percentages for context, and truncating large results to a readable limit, such as 20 rows. Finally, the adaptive query engine 216 transmits the requested data 392″ to the client device 202 to render the formatted result for the user.

The data builder and output phases provide a number of technical advantages. Using the data builder to generate the executable instructions (e.g., the dataflow graph 382) based on metadata shifts the burden of complex join mechanics and topology traversal away from an interpreter and onto a deterministic, metadata-driven execution engine. Additionally, the data review subgraph acts as a critical quality gate. This structure shifts troubleshooting away from blind textual prompt revisions and toward actual data probing, which prevents structural mismatches and mitigates AI hallucinations before results reach the user.

In some examples, the system can implement persona-based output customization to tailor technical depth based on the audience, utilizing high-level summaries for executives while providing execution metadata and join semantics for data engineers. For agent-to-agent interactions via an application programming interface, the output format can minimize user interface syntax in favor of raw JSON, CSV, or other structures. Furthermore, the system can provide the agents with a dynamic data retrieval tool to fetch beyond a static row limit if a detected data pattern is incomplete, alongside arithmetic tools that allow large language models to accurately calculate sums or percentages without relying on error-prone in-context math. In some examples, the output can evolve into an insights and follow-up subgraph capable of generating contextual follow-up questions, supplemented by integrated charting tools that dynamically render visualizations in-line with the markdown response.

In some examples, the context-driven data identification and generation system described herein can be integrated as a component of, or operate in coordination with, a broader context-driven orchestration engine and language model studio (LMS). A configuration system can configure the context-driven orchestration engine by mapping specific user interface locations to navigation context candidates, strategy candidates, function candidates, and prompt template candidates. For instance, a LMS can be utilized to define and store these candidates in a storage device. The function candidates can specify executable functions that are available for an interpreter (e.g., the AI service 226) to call to retrieve additional information from the metadata store 220, such as executing data queries against an application programming interface of the metadata model or running simple reports. The prompt templates can specify rules for the generated response, such as instructing the interpreter to respond in a user's native language (e.g., English or German) while maintaining domain-specific terms untranslated, or instructing the interpreter to cite sources using footnotes and links to the metadata model.

During operation, when a request is received, the context-driven orchestration engine can identify a navigation context based on a user interface location specified in the request. Based on the determined navigation context and the request, the context-driven orchestration engine identifies a strategy for responding to the request. To provide effective guidance to the interpreter, the strategy can include one or several hypothetical user inputs paired with a natural-language description of a strategic response (e.g., instructing the interpreter to run a specific data query to find datasets related to a driving dataset). The context-driven orchestration engine can then generate a context-driven prompt utilizing a prompt template that specifies the request, the selected strategy, the available functions, and information describing the metadata model. By tailoring the functions, strategies, and prompts based on the precise context in which the request was made, the context-driven orchestration engine improves the accuracy of the interpreter's output and facilitates the interpreter in providing valid, executable responses.

In some scenarios, the interpreter can leverage the provided function candidates to independently disambiguate the intent of a request. For example, if the interpreter identifies that a logical node within the metadata model, such as “Amount,” is ambiguous because it could refer to a transaction amount or a debt amount, the interpreter can transmit a request to execute a simple report function. In response, the system executes the report function against the metadata model to return a description of the logical node (e.g., “Total cost for a single transaction”) to the interpreter. This dynamic retrieval of context allows the interpreter to confidently generate accurate instructions for the data builder 228 without relying on manual intervention.

Furthermore, the context-driven data identification and generation system described herein can be integrated with and used to generate data or data definitions for a data marketplace. A data marketplace can operate as a cloud data fabric including a centralized architecture and a set of tools, such as a data catalog, that unifies and integrates data from various sources, connecting data builders with data consumers. Rather than merely outputting raw data, the data builder 228 can automatically register a newly generated dataset within the data marketplace. Registering the dataset can include storing information identifying the dataset, such as a name and a logical definition of how to generate the dataset, in a datasets storage device. Utilizing a logical definition enables access to the dataset without the immediate computational cost of physically materializing the dataset itself. In some examples, the data builder 228 can generate a preview of the dataset to be registered based on the definition and apply appropriate controls to ensure data quality before finalizing the registration. Upon registration, the system can update the metadata model by adding a new dataset node representing the newly registered dataset, along with new logical nodes and edges specifying relationships to existing nodes. This facilitates the automatic application of rules, controls, and other logic defined within the metadata model to the dataset whenever it is materialized or accessed by a data consumer via the data marketplace. For instance, when a data consumer subsequently requests the registered dataset, the data builder 228 retrieves the stored definition and transforms it into an executable computer program to physically generate the dataset from multiple distinct data sources. During this execution, the system dynamically enforces the controls specified in the metadata model, such as masking social security numbers or applying data quality rules to ensure a date of birth satisfies a specific threshold (e.g., on or after Jan. 1, 1925). If a processed data item fails an applied control, the materialized dataset can output an indication that the particular data item failed the data quality rule, thereby ensuring automated, decentralized data governance.

In some examples, the data resolution engine 212 and/or other components described herein can be integrated as a component of, or operate in coordination with, a broader context-driven orchestration engine and language model studio. A configuration system can configure the context-driven orchestration engine by mapping specific user interface locations to navigation context candidates, strategy candidates, function candidates, and prompt template candidates. For instance, when a request is received, the context-driven orchestration engine can identify a navigation context based on a user interface location specified in the request. Based on the determined navigation context and the request, the context-driven orchestration engine identifies a strategy for responding to the request. The strategy can specify one or more instructions, as well as functions that are available for an interpreter (e.g., the AI service 226) to call to retrieve additional information from the metadata store 220. The context-driven orchestration engine can then generate a context-driven prompt utilizing a prompt template that specifies the request, the strategy, the available functions, and information describing the metadata model. By tailoring the functions, strategies, and prompts based on the precise context in which the request was made, the context-driven orchestration engine improves the accuracy of the interpreter's output and facilitates the interpreter in providing valid, executable responses.

Furthermore, the context-driven data identification and generation system described herein can be integrated with and used to generate data or data definitions for a data marketplace. A data marketplace can include a centralized architecture and a set of tools, such as a data catalog, that unifies and integrates data from various sources, connecting data builders with data consumers. Instead of, or in addition to outputting raw data, the data builder 228 can automatically register a newly generated dataset within the data marketplace. Registering the dataset can include storing information identifying the dataset, such as a name and a definition of how to generate the dataset, in a datasets storage device. In some examples, the data builder 228 can generate a preview of the dataset to be registered based on the definition and apply appropriate controls to ensure data quality before finalizing the registration. Upon registration, the system can update the metadata model by adding a new dataset node representing the newly registered dataset, along with new logical nodes and edges specifying relationships to existing nodes. This facilitates the automatic application of rules, controls, and other logic defined within the metadata model to the dataset whenever it is materialized or accessed by a data consumer via the data marketplace.

Referring to FIG. 4, an example metadata model 400 is shown. In general, a metadata model is a structured representation of metadata and relationships among the metadata. For example, the metadata model can be an object model or a data structure (e.g., a schema) that includes nodes representing items of metadata (e.g., technical or logical metadata) and edges representing relationships among the items of metadata. In general, technical metadata includes metadata that describes attributes of stored data, such as its technical name (e.g., dataset name, field name, etc.). Logical metadata includes metadata that gives meaning or context to data, such as its semantic or business name.

A node can be a data object or other data structure that includes values for attributes of the item of metadata that it represents. The attributes included in a node can depend on the type or class of metadata that the node represents. For example, a node representing a dataset can include a dataset name attribute that is populated with the name of the dataset that the node represents.

An edge can be a reference, a pointer, a data object, or another data structure that specifies a relationship between nodes. In some examples, an edge can represent a hierarchical relationship between nodes (e.g., a parent-child relationship), such as a relationship between a dataset node (the parent) and a node of a technical data element it contains (the child). As another example, an edge can represent an associative relationship between nodes, such as a relationship between a technical data element node and a logical data element node that describes or gives meaning to the technical data element node.

In this example, the metadata model 400 is a multi-tiered metadata model that includes several tiers or layers corresponding to different types of metadata, with nodes in a given layer representing an item of metadata of that type. For example, the metadata model 400 has a dataset layer that includes nodes 402a, 402b specifying metadata for datasets that are stored in a data store or other storage device. Each of the nodes 402a, 402b can specify values for one or more attributes of a dataset, such as the name of the dataset. Although only two nodes 402a, 402b are shown in this example, other examples can include many more nodes (e.g., thousands or millions) representing all of the datasets stored in a data processing system. Additional details regarding metadata models having distinct types of nodes are described in U.S. patent application Ser. No. 18/987,691, titled “A Development Environment For Automatically Generating Code Using A Multi-Tiered Metadata Model,” the entire contents of which are incorporated herein by reference.

Above the dataset layer is a technical data element (TDE) layer that includes nodes 404a-404f specifying metadata for TDEs (e.g., columns or fields) of a dataset. For example, each of the nodes 404a-404f can specify a name of the corresponding TDE, among other attributes. In this example, the nodes 404a, 404b, 404c represent TDEs of the dataset corresponding to the node 402a, and the nodes 404d, 404e, 404f represent TDEs of the dataset corresponding to the node 402b. To establish this relationship in the metadata model 400, each of the TDE nodes 404a, 404b, 404c can be connected to the dataset node 402a by an edge (e.g., a reference, a pointer, a data object, etc.), and each of the TDE nodes 404d, 404e, 404f can be connected to the dataset node 402b by an edge.

The metadata model 400 also includes a logical data elements layer. In general, nodes 406a, 406b in the logical data elements layer specify logical names, terms, or other metadata that describes or gives meaning to TDEs and their underlying data. To identify such a link or association between a logical data element and a TDE, semantic discovery processes can be used in which a series of statistical checks on a TDE and its associated data are performed in order to discover, classify, and label the TDE (and its data) with a logical data element representing their semantic meaning. Additional details regarding semantic discovery processes are described in U.S. Pat. No. 11,704,494, titled “Discovering a semantic meaning of data fields from profile data of the data fields,” the entire content of which is incorporated herein by reference.

In this example, the TDE nodes 404a, 404e each relate to the same logical concept represented by the logical data element node 406a, and the TDE nodes 404b, 404f each relate to the same logical concept represented by the logical data element node 406b. Stated differently, the logical data element node 406a describes or gives meaning (e.g., a semantic meaning) to each of the TDE nodes 404a, 404e, and the logical data element node 406b describes or gives meaning to each of the TDE nodes 404b, 404f. The logical data element nodes 406a, 406b can also describe or give meaning to other TDE nodes, as depicted in FIG. 4. Accordingly, the TDE nodes 404a, 404e are linked (e.g., by edges) to the logical data element node 406a, and the TDE nodes 404b, 404f are linked to the logical data element node 406b. By linking TDEs and logical data elements, valuable context can be provided to the cryptic names of TDEs (e.g., X152) that convey little about the type of information they represent.

Above the logical data elements layer is a logical data element groups layer that includes a node 408 specifying metadata that defines a broader grouping or categorization for the underlying logical data elements. In this example, the node 408 defines a hierarchical group that encompasses the logical concepts represented by the nodes 406a, 406b, and is therefore linked to each of the logical data element nodes 406a, 406b by edges. This hierarchical grouping enables broader semantic organization and alignment across the enterprise data ecosystem, allowing related logical data elements to be aggregated or classified under a shared umbrella concept.

While the example metadata model 400 illustrated in FIG. 4 depicts a particular set of layers, additional or alternative layers can be used in some examples without departing from the scope of the present disclosure. For example, one or more additional logical layers, such as a business term layer, can be included to map the logical data elements to specific organizational lexicons. In addition, although the metadata model 400 depicts a particular number of nodes in each layer, additional (or fewer) nodes can be included in some examples without departing from the scope of the present disclosure.

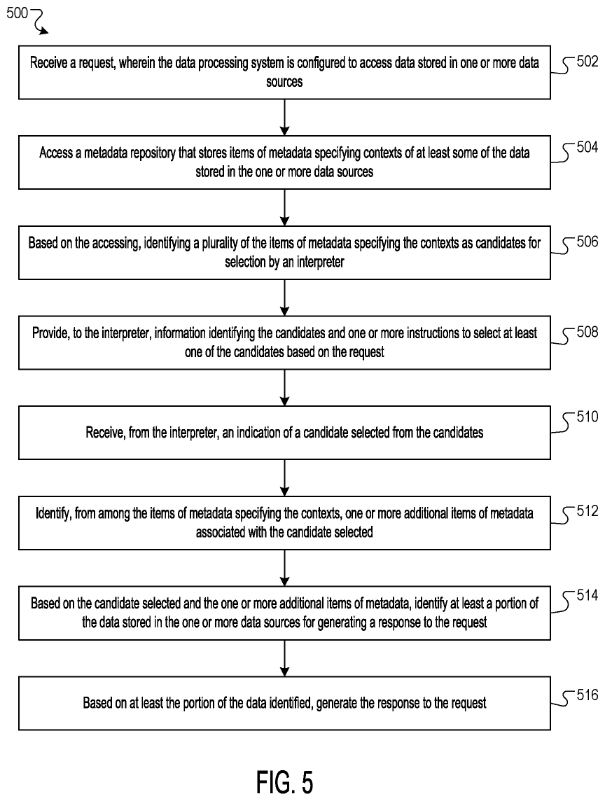

Referring to FIG. 5, example process 500 for context-driven data identification and materialization is shown. Operations of the process 500 include receiving (502), by a data processing system receiving, a request. In this example, the data processing system can be configured to access data stored in one or more data sources. At 504, the data processing system accesses a metadata repository that stores items of metadata specifying contexts of at least some of the data stored in the one or more data sources. Based on the accessing, the data processing system identifies (506) one or more of the items of metadata specifying the contexts as candidates for selection by an interpreter. At 508, information identifying the candidates and one or more instructions to select at least one of the candidates based on the request is provided to the interpreter. An indication of a candidate selected from the candidates is received (510) from the interpreter. The data processing system identifies (512), from among the items of metadata specifying the contexts, one or more additional items of metadata associated with the candidate selected. Based on the candidate selected and the one or more additional items of metadata, the data processing system identifies (514) at least a portion of the data stored in the one or more data sources for generating a response to the request. Based on at least the portion of the data identified, the data processing system generates (516) the response to the request.

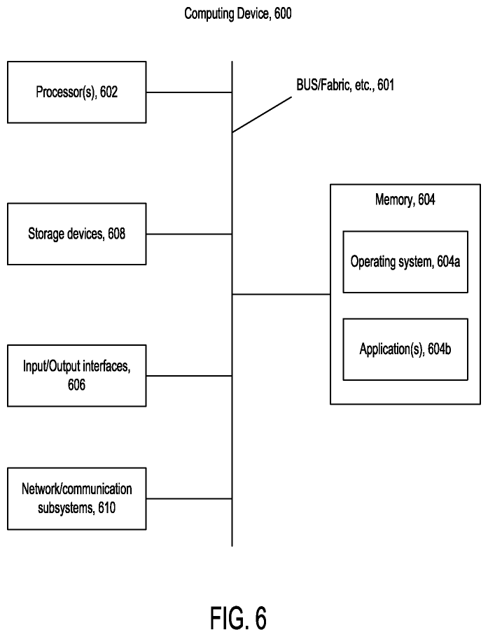

Referring to FIG. 6, an example operating environment for implementing embodiments of the present disclosure is shown and designated generally as computing device 600. The computing device 600 (also referred to as a computer or data processing system or client or server) includes one or more programmable processors 602 for performing actions in accordance with instructions and one or more memory devices 604 for storing instructions and data. Generally, a computer will also include, or be operatively coupled, (via bus 601, fabric, network, etc. ,) to I/O components 606, e.g., display devices, network/communication subsystems, etc. (not shown) and one or more mass storage devices 608 for storing data and instructions, etc., and a network communication subsystem 610, which are powered by a power supply (not shown). In memory 604, are an operating system 604a and applications 604b for application programming.

The computer program instructions and data may be stored in non-transitory form, such as being embodied in a volatile or non-volatile storage medium, or any other non-transitory medium, using a physical property of the medium (e.g., surface pits and lands, magnetic domains, or electrical charge) for a period of time (e.g., the time between refresh periods of a dynamic memory device such as a dynamic RAM). In preparation for loading the instructions, the software may be provided on a tangible, non-transitory medium, such as a CD-ROM or other computer-readable medium (e.g., readable by a general or special purpose computing system or device), or may be delivered (e.g., encoded in a propagated signal) over a communication medium of a network to a tangible, non-transitory medium of a computing system where it is executed. Some or all of the processing may be performed on a special purpose computer, or using special-purpose hardware, such as coprocessors or field-programmable gate arrays (FPGAs) or dedicated, application-specific integrated circuits (ASICs). The processing may be implemented in a distributed manner in which different parts of the computation specified by the software are performed by different computing elements. Each such computer program is stored on or downloaded (from a cloud computing infrastructure or other remote source) to a computer-readable storage medium (e.g., solid state memory or media, or magnetic or optical media) of a storage device accessible by a general or special purpose programmable computer, for configuring and operating the computer when the storage device medium is read by the computer to perform the processing described herein. Each such computer program may also be accessed as a service provided by cloud computing infrastructure. The embodiments described herein may also be implemented as a tangible, non-transitory medium, configured with a computer program, where the medium so configured causes a computer to operate in a specific and predefined manner to perform one or more of the processing steps described herein.

The computer program may include one or more modules of a larger program, for example, which provides services related to the design, configuration, and execution of dataflow graphs. The modules of the program (e.g., elements of a dataflow graph) can be implemented as data structures or other organized data conforming to a data model stored in a data repository.

To provide for interaction with a user, embodiments of the subject matter described in this specification can be implemented on a computer having a display device (monitor) for displaying information to the user, and a keyboard and a pointing device, (e.g., a mouse or a trackball) by which the user can provide input to the computer. In addition, a computer can interact with a user by sending documents to and receiving documents from a device that is used by the user (for example, by sending web pages to a web browser on a user's device in response to requests received from the web browser).

Embodiments of the subject matter described in this specification can be implemented in a computing system that includes a back end component (e.g., as a data server), or that includes a middleware component (e.g., an application server), or that includes a front end component (e.g., a user computer having a graphical user interface or a Web browser through which a user can interact with an implementation of the subject matter described in this specification), or any combination of one or more such back end, middleware, or front end components. The components of the system can be interconnected by any form or medium of digital data communication (e.g., a communication network). Examples of communication networks include a local area network (“LAN”), a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the user device). Data generated at the client device (e.g., a result of the user interaction) can be received from the client device at the server.

A computation can be expressed as data flow through a computational graph with nodes and links. The computation includes components specifying portions of the computation. A node represents one or more of these components. The nodes are connected by the links to represent data flow, such as flow of data records, among the components. As such, a computational graph may also be referred to as a dataflow graph. The dataflow graph itself is executable, e.g., by compiling or otherwise processing the dataflow graph to generate executable computer code.

As described herein, dataflow graph components include data processing components and/or datasets. A dataflow graph can be represented by a directed graph that includes nodes or vertices, representing the dataflow graph components, connected by directed links or data flow connections, representing flows of work elements (i.e., data) between the dataflow graph components. The data processing components include code for processing data from at least one data input, (e.g., a data source) and providing data to at least one data output, (e.g., a data sink) of a system. The dataflow graph can thus implement a graph-based computation performed on data flowing from one or more input datasets through the graph components to one or more output datasets.

A component may be an upstream component, a downstream component, or both. An upstream component includes a component that outputs data to another component. A downstream component includes a component that receives data from another component. Additionally, components include input and output ports. The links are directed links that are coupled from an output port of an upstream component to an input port of a downstream component. The ports have indicators that represent characteristics of how data is written to and read from the links and/or how the components are controlled to process data.

These ports may have various characteristics. For example, one characteristic of a port is its directionality as an input port or output port. The directed links represent data and/or control being conveyed from an output port of an upstream component to an input port of a downstream component.

A subset of the components serves as sources and/or sinks of data from the overall computation, for example, to and/or from data files, database tables, and external data flows. Parallelism can be achieved at least by enabling different components to be executed in parallel by different processes (hosted on the same or different server computers or processor cores), where different components executing in parallel on different paths through a dataflow graph is referred to as component parallelism, and different components executing in parallel on different portions of the same path through a dataflow graph is referred to as pipeline parallelism.

A system also includes a data processing system for executing one or more computer programs (such as dataflow graphs), which were generated by the transformation of a specification into the computer program(s) using a transform generator. In some examples, the transform generator may transform a specification into entity, e.g., by selecting from a data repository those dataflow graph components or data representing components that are specified by the operation types in the specification. Generally, an “entity” includes a portion of a computer program (e.g., a pre-defined portion of a computer program for inclusion in another computer program) or one or more dataflow graph components (e.g., that are encapsulated together into a pre-defined module). The transform generator may also access, in a data storage system, a data structure that maps data representing portions of a specification to data representing components or dataflow graph components. Transform generator identifies, in the mapping, an item of data representing a particular portion of the specification. Transform generator identifies, in the mapping, which data representing a component or a dataflow graph component is mapped to the identified portion of the specification; and adds the identified data representing component or dataflow graph component to the entity.

While this specification contains many specific implementation details, these should not be construed as limitations on the scope of any inventions or of what may be claimed, but rather as descriptions of features specific to particular embodiments of particular inventions.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments, and it should be understood that the described program components and systems can generally be integrated together in a single software product or packaged into multiple software products.

A number of embodiments have been described. Nevertheless, it will be understood that various modifications may be made without departing from the spirit and scope of the techniques described herein. For example, some of the steps described above may be order independent, and thus can be performed in an order different from that described. Additionally, any of the foregoing techniques described with regard to a dataflow graph can also be implemented and executed with regard to a program. Accordingly, other embodiments are within the scope of the following claims.

What is claimed is:

1. A method for efficiently identifying data for responding to a request by identifying metadata candidates specifying contexts of available data, utilizing an interpreter to select a candidate, based on the selection, retrieving additional metadata specifying additional contexts and using that additional metadata to identify the data for the response to the request, the method including:
receiving, by a data processing system, a request, wherein the data processing system is configured to access data stored in one or more data sources;
accessing, by the data processing system, a metadata repository that stores items of metadata specifying contexts of at least some of the data stored in the one or more data sources;
based on the accessing, identifying, by the data processing system, a plurality of the items of metadata specifying the contexts as candidates for selection by an interpreter;
providing, to the interpreter, information identifying the candidates and one or more instructions to select at least one of the candidates based on the request;
receiving, from the interpreter, an indication of a candidate selected from the candidates;
identifying, from among the items of metadata specifying the contexts, one or more additional items of metadata associated with the candidate selected;
based on the candidate selected and the one or more additional items of metadata, identifying at least a portion of the data stored in the one or more data sources for generating a response to the request; and
based on at least the portion of the data identified, generating, by the data processing system, the response to the request.

2. The method of claim 1, wherein a context specifies a semantic meaning of an item of data stored in the one or more data sources.

3. The method of claim 1, wherein the interpreter includes an artificial intelligence (AI) service or a client device.

4. The method of claim 1, wherein generating the response to the request includes:
generating, by the data processing system, instructions configured to access the at least a portion of the data stored in the one or more data sources and to output, based on the accessed data, the response to the request; and
executing, by the data processing system, the instructions on the at least a portion of the data stored in the one or more data sources to output the response.

5. The method of claim 4, wherein generating the response to the request includes:
identifying one or more keys for joining the identified data;
wherein generating the instructions includes generating instructions configured to join the identified data based on the one or more keys; and
wherein executing the instructions includes joining the identified data based on the one or more keys.

6. The method of claim 1, including:
identifying technical metadata corresponding to at least one of the candidate selected or the one or more additional items of metadata; and
based on the technical metadata, identifying the at least a portion of the data stored in the one or more data sources for generating a response to the request.

7. The method of claim 1, wherein each of the plurality of the items of metadata is associated with a group of data, and wherein the one or more additional items of metadata are associated with data within the group corresponding to the candidate selected.

8. The method of claim 1, including:
providing, to the interpreter, information identifying the one or more additional items of metadata and one or more instructions to select, based on the request, at least one of the one or more additional items of metadata;
receiving, from the interpreter, an indication of at least one of the one or more additional items of metadata; and
wherein the data of the one or more data sources to be used in responding to the request is identified based on the at least one of the one or more additional items of metadata.

9. The method of claim 8, including:
determining one or more errors associated with the at least one of the one or more additional items of metadata identified; and
providing instructions to the interpreter to select a candidate from the candidates based on the one or more errors.

10. The method of claim 1, wherein identifying the additional items of metadata includes:
accessing a metadata model that includes data representing the items of metadata and relationships among the items of metadata;
identifying, in the metadata model, the candidate selected; and
traversing the metadata model to identify the one or more additional items of metadata.

11. The method of claim 10, wherein the metadata model includes nodes representing the items of metadata and edges representing relationships among the items of metadata, and wherein traversing the metadata model includes traversing one or more edges associated with a node representing the candidate selected to identify one or more other nodes representing the one or more additional items of metadata.

12. The method of claim 1, including:
identifying one or more rules associated with the candidate selected; and
determining at least one of the one or more additional items of metadata by applying the one or more rules.

13. The method of claim 1, including:
accessing a workflow that specifies a sequence of operations for identifying at least a portion of the data, wherein at least some of the operations in the sequence are to be performed by one of a plurality of interpreters; and
based on the workflow, providing, to the interpreter, the information identifying the candidates and the one or more instructions to select at least one of the candidates.

14. The method of claim 13, including:
identifying, based on the workflow, a second interpreter of the plurality of interpreters for selecting at least one of the one or more additional items of metadata for responding to the request; and
providing, to the second interpreter, information identifying the one or more additional items of metadata and one or more instructions to select, based on the request, at least one of the one or more additional items of metadata.

15. The method of claim 1, including:
providing, to each of a plurality of interpreters, a portion of the one or more additional items of metadata and one or more instructions to select, from the portion, items of metadata for responding to the request;
receiving, from each of the plurality of interpreters, selected items of metadata from the respective portion; and
generating the response based on the selected items of metadata received from each of the plurality of interpreters.

16. The method of claim 1, including providing, to the interpreter, instructions to determine whether all components of the request are satisfied based on the candidate selected and the one or more additional items of metadata.

17. The method of claim 1, including:
providing, to the interpreter, one or more instructions to generate a declarative specification for identifying the at least a portion of the data for generating the response to the request;
receiving, from the interpreter, the declarative specification; and
based on the declarative specification, generating executable instructions for outputting the response to the request.

18. The method of claim 1, including:
identifying contextual information for the request based on a user associated with the request or a location within a user interface from which the request was initiated; and
identifying, based on the contextual information, the plurality of the items of metadata specifying the contexts; or
providing the contextual information to the interpreter to guide the selection of the candidate.

19. A system, including:
one or more processors; and
memory storing instructions executable by the one or more processors to perform operations including:
receiving a request, wherein the system is configured to access data stored in one or more data sources;
accessing a metadata repository that stores items of metadata specifying contexts of at least some of the data stored in the one or more data sources;
based on the accessing, identifying a plurality of the items of metadata specifying the contexts as candidates for selection by an interpreter;
providing, to the interpreter, information identifying the candidates and one or more instructions to select at least one of the candidates based on the request;
receiving, from the interpreter, an indication of a candidate selected from the candidates;
identifying, from among the items of metadata specifying the contexts, one or more additional items of metadata associated with the candidate selected;
based on the candidate selected and the one or more additional items of metadata, identifying at least a portion of the data stored in the one or more data sources for generating a response to the request; and
based on at least the portion of the data identified, generating, by the data processing system, the response to the request.

20. One or more non-transitory computer-readable storage mediums storing instructions executable by one or more processors to perform operations including:
receiving a request, wherein the one or more processors are configured to access data stored in one or more data sources;
accessing a metadata repository that stores items of metadata specifying contexts of at least some of the data stored in the one or more data sources;
based on the accessing, identifying a plurality of the items of metadata specifying the contexts as candidates for selection by an interpreter;
providing, to the interpreter, information identifying the candidates and one or more instructions to select at least one of the candidates based on the request;
receiving, from the interpreter, an indication of a candidate selected from the candidates;
identifying, from among the items of metadata specifying the contexts, one or more additional items of metadata associated with the candidate selected;
based on the candidate selected and the one or more additional items of metadata, identifying at least a portion of the data stored in the one or more data sources for generating a response to the request; and
based on at least the portion of the data identified, generating, by the data processing system, the response to the request.
